(19) United States
(12) Patent Application Publication
(10) Pub. No.: US 2007/0220615 A1
(43) Pub. Date: Sep. 20, 2007

(54) Frame relay device and frame inspection device

(75) Inventor: Jun Ogawa, Kawasaki (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/487,982

(22) Filed: Jul. 18, 2006

(30) Foreign Application Priority Data
Mar. 20, 2006 (JP) 2006-076466

(51) Int. Cl. G06F 17/30

(52) U.S. Cl. 726/30

(57) ABSTRACT

Provided is a frame relay device that relays a frame that is transferred from a terminal to a network, the frame relay device including: a determination section that determines whether or not an inspection of security of the frame from the terminal is necessary before frame transmission from the terminal to the network starts; a decision section that decides that the inspection of the security is not conducted on the frame from the terminal in an inspection device, and decides that the inspection of the security is not conducted on the frame from the terminal in the inspection device in a case where the inspection of the security is necessary; and an output section that outputs an instruction based on the decision result to the inspection device.

### BACKGROUND OF THE INVENTION

1. Technical Field

The present invention relates to an increase in processing speed of an attack detection device on a network.

2. Background Art

In recent years, there are increasing attacks that are difficult to detect by a check at a transport layer level (for example, port filtering at a TCP/UDP layer level), such as an attack using a computer virus that is attached to an e-mail. Up to now, in order to detect the attack of that type, there are two options including a detecting method performed by a device on the network and detecting method performed by an end terminal.

The detecting method performed by the device on the network is a method of detecting the attack by combination of fraud detection (pattern check) with failure detection (check using a threshold value) at a connection portion of an enterprise network such as an enterprise network or an in-school network with an external network. The devices having those detecting functions are generally called “IDS (intrusion detection system)”. FIG. 33 is a diagram showing the structure of a general network.

The fraud detection (pattern check) is a method of checking the header or data of a frame by application of a pattern file that is distributed for each of the attack patterns to detect the attacks using a known way. The pattern file is always updated in order to cope with the newest attack, and the newest pattern file is provided on the internet.

The failure detection (check using the threshold value) is a method of monitoring the action of traffics in each of flows on the network, and checks whether or not the failure actions occur over the threshold value. According to this method, there is a possibility of finding out an attack using an unknown manner.

The detecting methods can be classified into a network type and a host type according to an arrangement of the system that conducts the detection.

According to the network type, all of the traffics of the connected network segments are monitored by using a promiscuous mode (unconditional receive mode) of a network card. More specifically, according to the network type, packets are collected on the network, and the protocol header and data are analyzed. When a hacker attempts an unauthorized access, the hacker transmits the packets of a fraud format and connects to a port related to a service where there is a security hole. In this event, the suspicious packet is found and notified. The promiscuous mode is an operation mode in which all of packets are taken in on the network which are not addressed to its own node in a network interface.

According to the host type, an unauthorized access is detected in association with the monitoring function of the OS (operating system). The host type is introduced into a computer to be protected, thereby monitoring log files and falsification of files.

The detecting method performed by an end terminal is a method of detecting the attack using virus check software and a security hole countermeasure patch.

The virus check software has a function of checking whether or not a virus is contained in a hard disk or a received e-mail, according to the pattern file. The pattern file is always updated so as to cope with the newest attacks, and the newest pattern file is provided, for example, via the Internet.

The security hole countermeasure patch blocks a security hole such as OS. The patch information is distributed from an OS vendor or the like with respect to the security hole, and is capable of preventing the attack by application of the patch information.

A connection protocol to the general network will be described with reference to FIG. 34.

A remote terminal 104 requests a connection to an enterprise network 114 with respect to a VPN-GW 103. In this event, a user of the remote terminal 104 transmits user authentication information (user name and password) for connection to the enterprise network 114 to the VPN-GW 103 (SQ 01). The VPN-GW 103 inquires of an authentication server 111 whether or not the user authentication information of the remote terminal 104 can be permitted to be connected to the enterprise network 114 (SQ 02). The authentication server 111 transmits the authentication result to the VPN-GW 103 (SQ 03). The VPN-GW 103 transmits the authentication results (connectable or not) which have been received from the authentication server 111 to the remote terminal 104 (SQ 04). In the case where the authentication is OK, the remote terminal 104 starts the encrypted communication with the VPN-GW 103 (SQ 05). The VPN-GW 103 terminates the encryption, and transfers the frame of the remote terminal 104 to the enterprise network 114 (SQ 05). The VPN-GW 103 implements fraud detection with respect to all of communications.
[Patent document 1] JP 2004-234208 A

### SUMMARY OF THE INVENTION

[Disclosure of the Invention]

[Problems to be Solved by the Invention]

The fraud detection by the network type IDS monitors all of the traffics of the connected network segment. When the flow rate of traffics increases, the analysis process of the fraud detection cannot follow the flow rate of traffics. For that reason, there arises such a problem that the fraud detection fails.

Also, the fraud detection conducted by the device on the network and the fraud detection at the end terminal are conducted, independently. For that reason, there arises such a problem that the fraud detection on the network is conducted even on the traffic from the safe terminal.

In view of the above circumstances, an object of the present invention is to promote efficiency of the fraud detection by selecting the traffic that conducts the fraud detection.

[Means for Solving the Problems]

The present invention adopts the following means to achieve the object. That is, according to an aspect of the present invention, there is provided a frame relay device for relaying a frame that is transferred from a terminal to a network, the frame relay device including:
a determination section that determines whether or not an inspection of security of the frame from the terminal is necessary before frame transmission from the terminal to the network starts;
a decision section that decides that the inspection of the security is not conducted on the frame from the terminal in an inspection device that is positioned on a frame transmission path between the frame relay device and the network, receives the frame that is transferred to the network, and conducts the inspection of the security of the frame in a case where the inspection of the security is unnecessary, and decides that the inspection of the security is not conducted on the frame from the terminal in the inspection device in a case where the inspection of the security is necessary; and
an output section that outputs an instruction based on the decision result to the inspection device.

According to the present invention, it is possible to suppress the inspection of the security with respect to the frame from a terminal that is not required to inspect the security from being conducted by the inspection device. In other words, the traffic that conducts the fraud detection is selected by the inspection device on the basis of an instruction from a frame relay device. As a result, an efficient inspection is realized.
Further, according to another aspect of the present invention, there is provided a frame inspection device including:
a frame reception section;
an inspection section that inspects security of a frame;
a storage section that registers identification information of a terminal that does not require inspection of the security by the inspection section therein; and
a determination section that determines not to inspect the frame by the inspection section in a case where the identification information of a transmission source terminal of the frame is not registered in the storage section when the frame is received by the frame reception section.

According to the present invention, the traffic that conducts the fraud detection is conducted with reference to a storage section. Then, it is possible to inspect the security of only the frame (traffic) which is required to inspect the security. Accordingly, the efficiency of the inspection by the inspection device is promoted. Also, a processing load of the inspection device is reduced.

Also, the present invention is capable of realizing a method having the same features as those of the frame relay device or the frame inspection device according to the present invention, a program that is executed by an information processing device (for example, a computer), or a recording medium in which the program is recorded.

[Effects of the Invention]

According to the present invention, the traffic that conducts the fraud detection is selected, thereby making it possible to promote the efficiency of the fraud detection.

### BRIEF DESCRIPTION OF THE DRAWINGS

FIG. 1 is a diagram showing a structural example of a system.

FIG. 2 is a diagram showing an example of a functional block of an IDS.

FIG. 3 is a diagram showing an example of a functional block of a VPN-GW.

FIG. 4 is a table showing a relationship between a received frame and a transferred functional block.

FIG. 5 is a diagram showing an example of a functional block of a remote terminal.

FIG. 6 is a table showing a relationship between a received frame and a transferred functional block.

FIG. 7 is a diagram showing an example of a functional block of an inventory management server.

FIG. 8 is a diagram showing an example of a sequence in the case where no fraud detection is conducted.

FIG. 9 is a diagram showing an example of a functional block flow of the remote terminal.

FIG. 10 is a diagram showing an example of a functional block flow of the VPN-GW.

FIG. 11 is a diagram showing an example of a functional block flow of the VPN-GW.

FIG. 12 is a diagram showing a format example of an inventory information request frame.

FIG. 13 is a table showing an example of correspondence of message types.

FIG. 14 is a diagram showing an example of a functional block flow of the remote terminal.

FIG. 15 is a diagram showing a structural example of an inventory.

FIG. 16 is a diagram showing an example of a functional block flow of the VPN-GW.

FIG. 17 is a diagram showing a format example of an inventory information reply frame.

FIG. 18 is a diagram showing an example of a functional block flow of an inventory management server.

FIG. 19 is a diagram showing a format example of a fraud detection confirmation reply frame.

FIG. 20 is a diagram showing an example of a functional block flow of the VPN-GW.

FIG. 21 is a diagram showing a format example of an IDS setting request frame.

FIG. 22 is a diagram showing an example of a functional block flow of the IDS.

FIG. 23 is a diagram showing a format example of an IDS setting end frame.

FIG. 24 is a diagram showing an example of a functional block flow of the VPN-GW.

FIG. 25 is a diagram showing an example of a functional block flow of the remote terminal.

FIG. 26 is a diagram showing an example of a functional block flow of the VPN-GW.

FIG. 27 is a diagram showing an example of a functional block flow of the IDS.

FIG. 28 is a diagram showing an example of a sequence in the case where fraud detection is conducted.

FIG. 29 is a diagram showing an example of a functional block flow of the VPN-GW.

FIG. 30 is a diagram showing an example of a functional block flow of the remote terminal.

FIG. 31 is a diagram showing an example of a functional block flow of the VPN-GW.

FIG. 32 is a diagram showing an example of a functional block flow of the IDS.

FIG. 33 is a diagram showing a structural example of a general network.

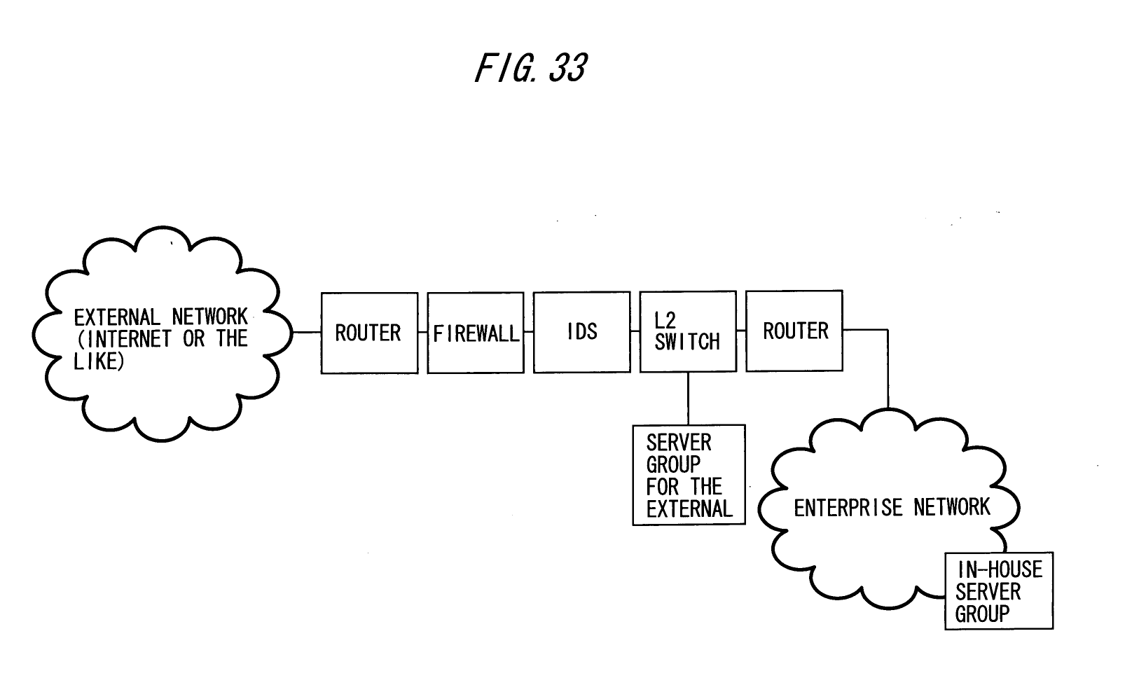

FIG. 34 is a diagram for explaining a general connection on the network.

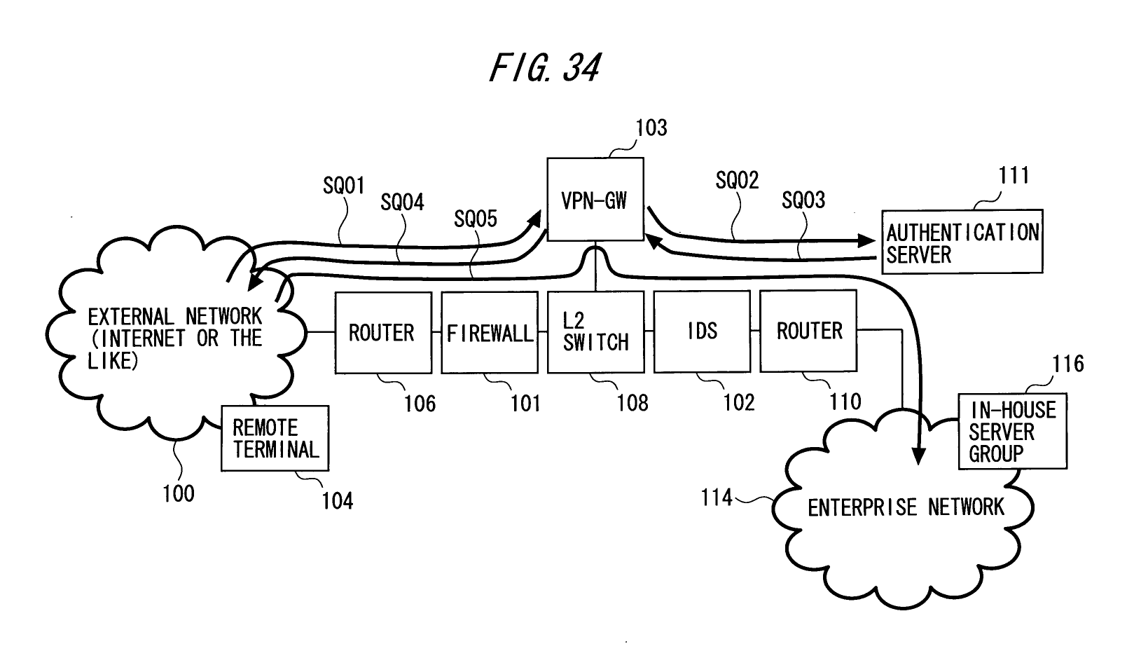

### DETAILED DESCRIPTION OF THE INVENTION

[Best Mode of Carrying out the Invention]

Hereinafter, a description will be given of embodiments of the present invention with reference to the accompanying drawings. The structures of the embodiments are mere examples, and the present invention is not limited to the structures of the embodiments.

### EMBODIMENTS

<System Structure>

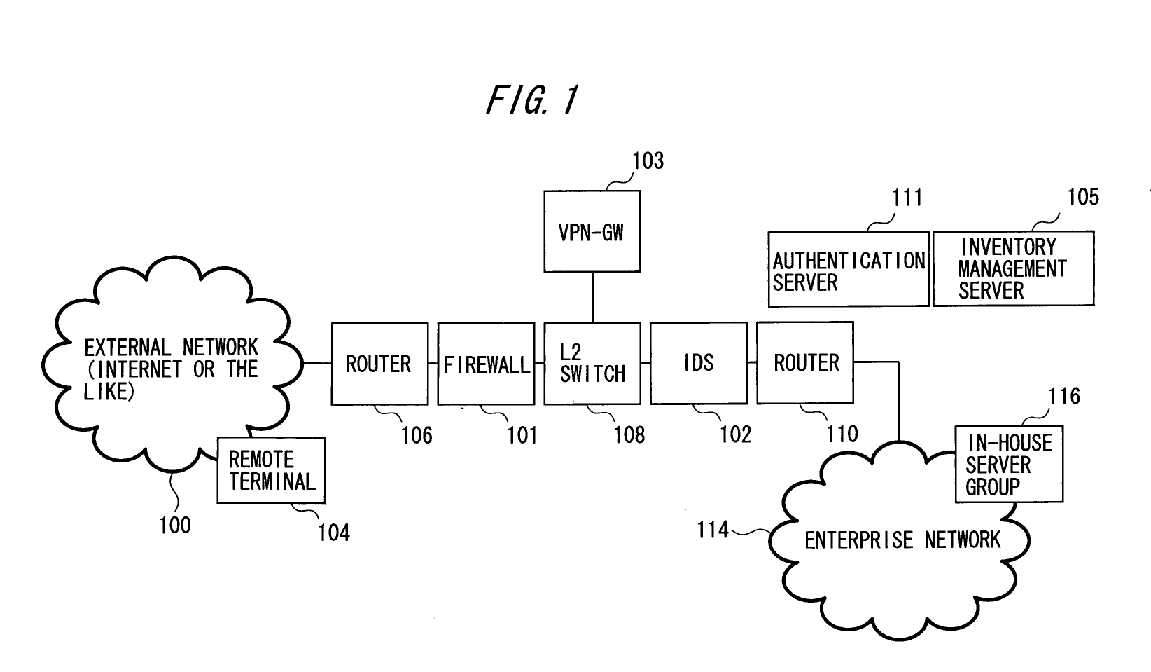

FIG. 1 is a diagram showing an example of a system structure according to an embodiment of the present invention. A system according to an embodiment of the present invention includes an enterprise network 114 of a company or the like, in-house servers 116, an authentication server 111, an inventory management server 105, a router 110, an L2 switch 108, an VPN-GW 103 (virtual private network—gate way) connected to the L2 switch, an IDS 102, a firewall 101 that separates the enterprise network 114 and an external network 100, a router 106, and the external network 100. The external network 100 is connected with a user remote terminal 104 of the enterprise network 114.

Hereinafter, a description will be given in more detail of the IDS 102, the VPN-GW 103, the remote terminal 104, and the inventory management server 105.

<<IDS>>

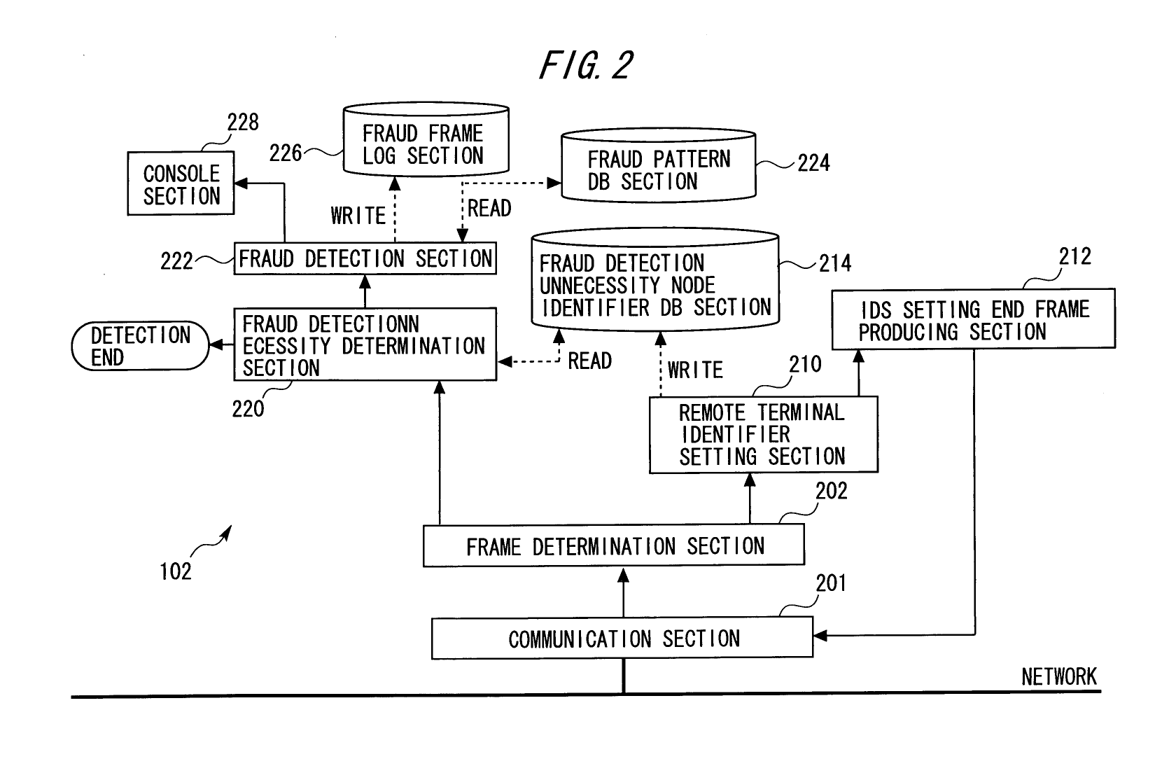

The IDS is a device that conducts fraud detection. FIG. 2 is a block diagram showing the function of the IDS 102. The IDS 102 includes a communication section 201, a frame determination section 202, a remote terminal identifier setting section 210, a fraud detection necessity determination section 220, a fraud detection section 222, a console section 228, a fraud frame log section 226, a fraud pattern DB 224, a fraud detection unnecessity node identifier DB 214, and an IDS setting end frame producing section 212.

(Communication Section)

The communication section 201 terminates a communication on the network to a link layer. The communication section 201 transmits a frame (received frame) that has been received on the network to the frame determination section 202.

(Frame Determination Section)

The frame determination section 202 identifies the kind of received frame that has been delivered from the communication section 201. In the case where the received frame is a frame to be transferred to the enterprise network 114 from the remote terminal 104, that is, a frame that has been received in a promiscuous mode, the frame determination section 202 delivers the received frame to the fraud detection necessity determination section 220. Also, in the case where the received frame is an IDS setting request frame, the frame determination section 202 delivers the received frame to the remote terminal identifier setting section 210.

(Remote Terminal Identifier Setting Section)

The remote terminal identifier setting section 210 stores an identifier (for example, IP address) of the remote terminal 104 that is included in the IDS setting request frame in the fraud detection unnecessity node identifier DB (database) section 214. The remote terminal identifier setting section 210 instructs the IDS setting end frame producing section 212 the production of the IDS setting end frame.

(Fraud Detection Unnecessity Node Identifier DB Section)

The fraud detection unnecessity node identifier DB section 214 holds information on a transmission source identifier (for example, IP address) which require no fraud detection. The information on the transmission source identifier that does not require the fraud detection is stored in the fraud node unnecessity node identifier DB section 214 by the remote terminal identifier determination section 210.

(IDS Setting End Frame Producing Section)

The IDS end frame producing section 212 produces the IDS setting end frame on the basis of an instruction from the remote terminal identifier setting section 210. The IDS setting end frame producing section 212 transmits the IDS setting end frame to the VPN-GW 103 through the communication section 201.

(Fraud Detection Necessity Determination Section)

The fraud detection necessity determination section 220 retrieves information that is held in the fraud detection unnecessity node identifier DB section 214 with the transmission source identifier (for example, IP address) of the received frame as a retrieve key, and determines whether or not the fraud detection process is required for the received frame. The fraud detection necessity determination section 220 completes the process for the frame in the case where the fraud detection is not required, and delivers the frame to the fraud detection section 222 in the case where the fraud detection is required.

(Fraud Detecting Section)

The fraud detection section 222 conducts the fraud detection as to whether or not the header or the data of the frame that is delivered from the fraud detection necessity determination section 220 is identical with a pattern that is held in the fraud pattern DB section 224. In the case where the header or the data is identical with the pattern, because the frame is fraud, the fraud detection section 222 scraps the frame, records information on the fraud frame (for example, transmission source/destination MAC address, transmission source/destination IP address) in the fraud frame log section 226, and notifies the console section 228 of the fact. In the case where the header or the data is not identical with the pattern, the fraud detection section 222 determines that the frame has no problem, and completes the processing of the frame.

(Console Section)

The console section 228 has an interface function with the user. In the case where the fraud frame is detected by the fraud detection section 222, the console section 228 notifies the user of the fact.

(Fraud Pattern DB Section)

The fraud pattern DB section 224 is a database section in which the patterns of the fraud frames are registered in advance. The fraud pattern DB section 224 is referred to when the fraud detection section 222 detects the fraud frame.

(Fraud Frame Log Section)

The fraud frame log section 226 holds the information on the frame that has been determined as the fraud frame by the fraud detection section 222.

<<VPN-GW>>

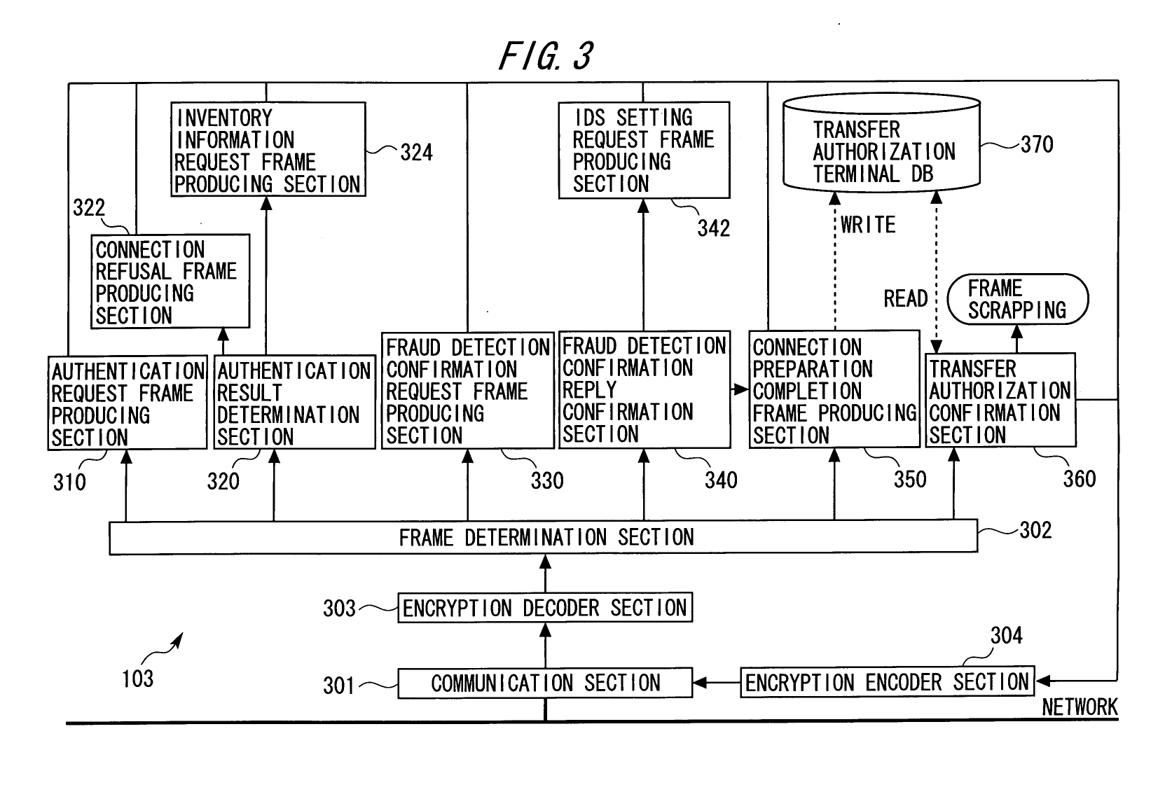

FIG. 3 is a block diagram showing the function of the VPN-GW 103.

The VPN-GW 103 includes a communication section 301, an encryption decoder section 303, an encryption encoder section 304, and a frame determination section 302. The VPN-GW 103 further includes an authentication request frame producing section 310, an authentication result determination section 320, a connection refusal frame producing section 330, a fraud detection confirmation response confirmation section 340, a connection preparation completion frame producing section 350, and a transfer authorization confirmation section 360. The VPN-GW 103 further includes a connection refusal frame producing section 322, an inventory information request frame producing section 324, an IDS setting request frame producing section 342, and a transfer enable terminal DB 370.

(Communication Section)

The communication section 301 terminates a communication on the network to a link layer, and delivers the communication to the encryption decoder section 303. Also, when the communication section 301 receives the frame from the encryption encoder section 304, the communication section 301 processes the link layer, and transmits the frame on the network.

(Encryption Decoder Section)

The encryption decoder section 303 decodes the encrypted frame, and then transfers the frame to the frame determination section 302. The encryption decoder section 303 transfers the unencrypted frame to the frame determination section 302 without decoding the unencrypted frame.

(Encryption Encoding Section)

The encryption encoder section 304 encrypts a frame that requires encryption (for example, a frame that is transmitted to the remote terminal 104), and transfers the frame to the communication section 301. The encryption encoder section 304 transfers the frame that does not require the encryption (for example, a frame that is transmitted to the IDS 102) to the communication section 301 without encrypting the frame.

(Frame Determination Section)

The frame determination section 302 identifies the kind of frame that has been received from the encryption decoder section 303. The frame determination section 302 transfers the frame to a subsequent function block according to the kind of frame.

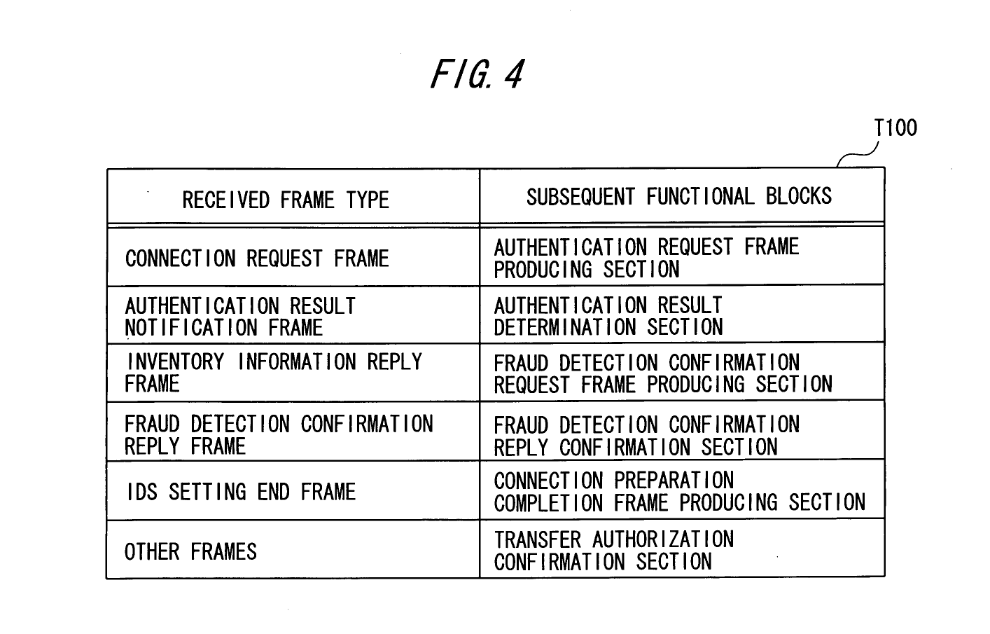

FIG. 4 is a table showing a relationship between the received frame and the function block to be transferred. A connection request frame is transferred to the authentication request frame producing section 310. An authentication result notification frame is transferred to the authentication result determination section 320. An inventory information reply frame is transferred to the fraud detection confirmation request frame producing section 330. A fraud detection confirmation reply frame is transferred to the fraud detection confirmation reply confirmation section 340. The IDS setting end frame is transferred to the connection preparation completion frame producing section 350. Other frames 365 are transferred to the transfer authorization confirmation section 360. The frame determination section 302 includes a table T100, which is shown in FIG. 4, for example, and transfers the frame with reference to the table T100.

(Authentication Request Frame Producing Section)

The authentication request frame producing section 310 produces an authentication request frame including the user authentication information (for example, user name or password) which is included in the connection request frame 315 received from the remote terminal 104, and transmits the authentication request frame to the authentication server 111 through the communication section 301.

(Authentication Result Determination Section)

The authentication result determination section 320 conducts processing on the basis of the authentication result notification frame that has been notified of from the authentication server 111 as a reply of the authentication request frame. In the case where the authentication is acceptable, the authentication result determination section 320 sends the inventory information request frame producing section 324 an instruction for transmitting an inventory information transmission request to the remote terminal 104 that has transmitted the connection request. In the case where the authentication is no permissible, the authentication result determination section 320 sends the connection refusal frame producing section 322 an instruction for transmitting the refusal of VPN connection to the remote terminal 104 that has transmitted the connection request.

(Connection Refusal Frame Producing Section)

The connection refusal frame producing section 322 produces a frame that notifies the refusal of the VPN connection from the remote terminal 104, and transmits the frame to the remote terminal 104 that has been instructed from the authentication result determination section 320 through the encryption encoder section 304.

(Inventory Information Request Frame Producing Section)

The inventory information request frame producing section 324 produces a frame that requests the inventory information of the remote terminal 104, and transmits the frame to the remote terminal 104 that has been instructed from the authentication result determination section 320 through the encryption encoder section 304.

(Fraud Detection Confirmation Request Frame Producing Section)

The fraud detection confirmation request frame producing section 330 produces the fraud detection confirmation request frame including the inventory information of the remote terminal 104 which has been obtained as a reply of the inventory information request frame, and then transfers the frame to the inventory management server 105.

(Fraud Detection Confirmation Reply Confirmation Section)

The fraud detection confirmation reply confirmation section 340 conducts processing on the basis of a reply result of the fraud detection confirmation reply frame which has been transmitted from the inventory management server 105. In the case where the fraud detection is unnecessary, the fraud detection confirmation reply confirmation section 340 instructs the IDS setting request frame producing section 342 to notify the IDS 102 that the frame transmitted by the remote terminal 104 which has transmitted the connection request after VPN connection is not subjected to the fraud detection process. In the case where the fraud detection is necessary, the fraud detection confirmation reply confirmation section 340 instructs the connection preparation completion frame producing section 350 to notify the remote terminal 104 which has transmitted the connection request that the connection preparation of the VPN-GW 103 has been completed.

(IDS Setting Request Frame Producing Section)

The IDS setting request frame producing section 342 produces the IDS setting request frame with an identifier of the remote terminal 104 which has been instructed from the fraud detection confirmation reply confirmation section 340 as an identifier (IP address, or the like) of the transmission source that does not conduct the fraud detection process. Then, the IDS setting request frame producing section 342 transmits the IDS setting request frame to the IDS 102 through the communication section 301.

(Connection Preparation Completion Frame Producing Section)

The connection preparation completion frame producing section 350 registers the identifier of the authenticated remote terminal 104 in the transfer authorization terminal DB 370. The connection preparation completion frame producing section 350 produces the connection preparation completion frame which notifies that the connection preparation of the remote terminal 104 has been completed in the VPN-GW 103, and transmits the connection preparation completion frame to the remote terminal 104 that has transmitted the connection request through the encryption encoder section 304.

(Transfer Authorization Confirmation Section)

The transfer authorization confirmation section 360 retrieves the transfer authorization terminal DB 370 with an identifier of a transmission source of the received frame as a retrieve key. In the case where an entry of the identifier exists in the transfer authorization terminal DB 370, because the received frame is a frame that is originated by the connection authorized (authenticated) remote terminal, the transfer authorization confirmation section 360 transfers the frame to a destination node within the enterprise network 114 through the encryption encoder section 304 and the communication section 301. In the case where no entry exists in the transfer authorization terminal DB 370, because the received frame is a frame that is originated by the connection unauthorized (unauthenticated) terminal, the transfer authorization confirmation section 360 scraps the frame.

(Transfer Authorization Terminal DB)

The transfer authorization terminal DB 370 is a database that holds an identifier of the authenticated remote terminal 104. The identifier of the authenticated remote terminal 104 is stored by the connection preparation completion frame producing section 350.

<<Remote Terminal>>

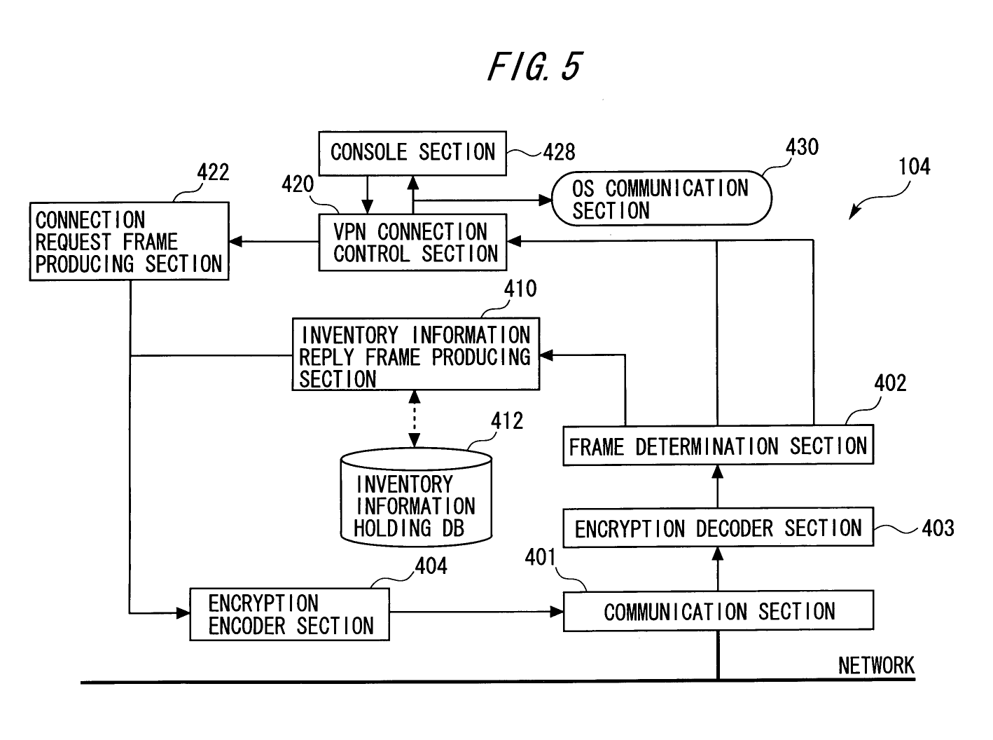

The remote terminal 104 is a terminal used when the user of the enterprise network 114 connects to the enterprise network 114 from the external network 100. FIG. 5 is a block diagram showing the function of the remote terminal 104.

The remote terminal 104 includes a communication section 401, an encryption decoder section 403, a frame determination section 402, an inventory information reply frame producing section 410, an inventory information holding DB 412, a VPN connection control section 420, a connection request frame producing section 422, a console section 428, and an OS communication section 430.

(Communication Section)

The communication section 401 terminates a communication on the network to a link layer, and delivers the frame to the encryption decoder section 403. Also, when the communication section 401 transmits the frame, the communication section 401 processes the link layer, and transmits the frame on the network.

(Encryption Decoder Section)

The encryption decoder section 403 decodes the encrypted frame, and then transfers the frame to the frame determination section 402. The encryption decoder section 303 transfers the unencrypted frame to the frame determination section 402 without decoding the unencrypted frame.

(Encryption Encoding Section)

The encryption encoder section 404 encrypts a frame that requires encryption, and transfers the frame to the communication section 401.

(Frame Determination Section)

The frame determination section 402 identifies the kind of frame that has been received from the encryption decoder section 403. The frame determination section 402 transfers the received frame to a subsequent function block according to the identification result. The inventory information request frame is transferred to the inventory reply frame producing section. The connection refusal frame and the connection preparation reply frame are transmitted to the VPN connection control section 420.

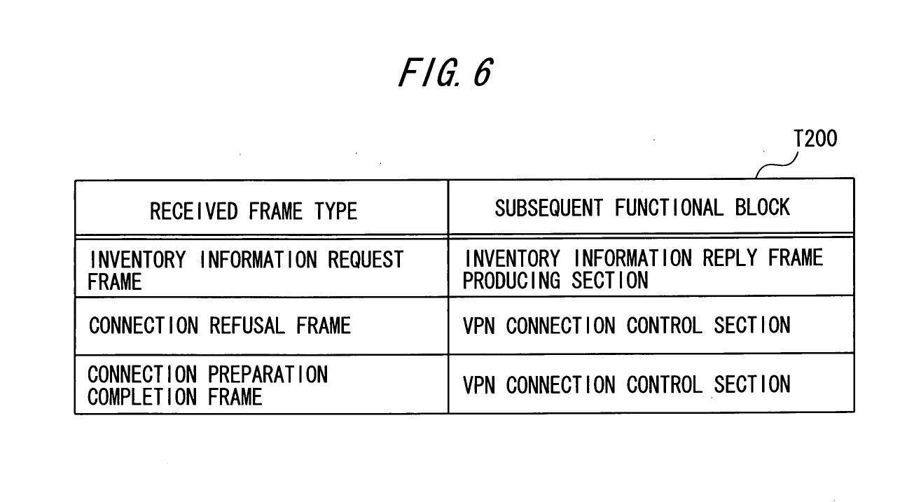

FIG. 6 is a table showing a relationship between the received frame and the function block to be transferred. An inventory information request frame is transferred to the inventory information reply frame producing section 410. The connection refusal frame and the connection preparation completion frame are transferred to the VPN connection control section 420. The frame determination section 402 includes a table T200, for example, which is shown in FIG. 6, and transfers the frame with reference to the table T200.

(Console Section)

The console section 428 has an interface function with the user. The console section 428 receives a notice of the notice items (connection preparation completion or connection refusal) from the VPN-GW 103 to the user, or an input of user authentication information (ID, password, or the like) necessary at the time of transmitting the VPN connection request from the user.

(VPN Connection Control Section)

The VPN connection control section 420 is a control section for allowing the remote terminal 104 to be VPN connected to the enterprise network 114. The VPN connection control section 420 instructs the connection request frame producing section 422 to produce the connection request frame including the inputted authentication information when receiving an instruction of the connection request from the console section 428.

When the VPN connection control section 420 fails authentication at the VPN-GW 103, and receives the connection refusal frame, the VPN connection control section 420 completes the connection process, and notifies the user through the console section 428.

When the VPN connection control section 420 succeeds the authentication at the VPN-GW 103 and receives the connection preparation completion frame, the VPN connection control section 420 notifies the OS communication section 430 of its own terminal that the VPN connection has executed, and further notifies the user through the console section 428.

(Connection Request Frame Producing Section)

The connection request frame producing section 422 produces the connection request frame according to an instruction from the VPN connection control section 420, and then transmits the connection request frame to the VPN-GW 103 through the encryption encoder section 404.

(Inventory Information Reply Frame Producing Section)

The Inventory reply frame producing section 410 acquires the inventory information that has been required from the VPN-GW 103 from the inventory information holding DB 412 to produce the inventory information reply frame. The inventory information reply frame is transmitted to the VPN-GW 103 through the encryption encoder section 404.

(Event Information Holding DB)

The inventory information holding DB 412 is a database section that holds the inventory information of the remote terminal 104. The inventory information of the remote terminal 104 is collected and stored in the inventory information holding DB 412 in advance.

<<Inventory Management Server>>

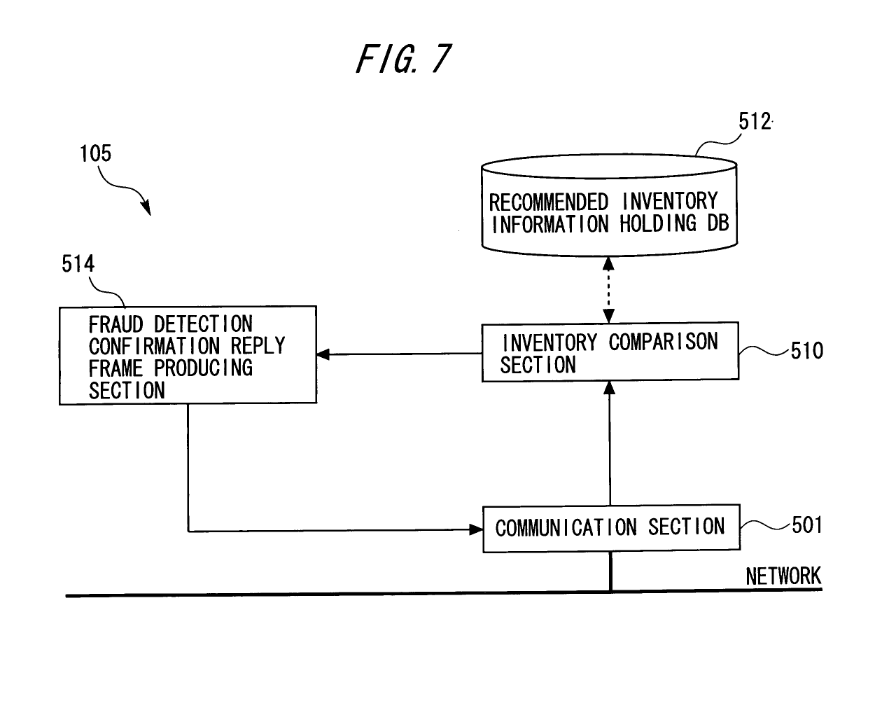

FIG. 7 is a block diagram showing the function of the inventory management server 105. The inventory management server 105 includes a communication section 501, an inventory comparison section 510, a recommended inventory information holding section 512, and a fraud detection confirmation reply frame producing section 514. The inventory management server 105 is located inside of the firewall 101 of the enterprise network 114.

(Communication Section)

The communication section 501 terminates a communication on the network to a link layer, and transfers the communication to the inventory comparison section 510. Also, the communication section 501 processes the link layer at the time of transmitting the frame, and transmits the frame to the network.

(Inventory Comparison Section)

The inventory comparison section 510 compares the inventory information of the remote terminal 104 that gives the VPN-GW 103 the connection request with the recommended inventory information within the recommended inventory information holding DB 512 to determine the necessity of the fraud detection in the IDS 102 with respect to the fraud detection confirmation request frame from the received VPN-GW 103. When the recommended inventory information coincides with the inventory information of the remote terminal 104, the inventory comparison section 510 determines that the fraud detection is unnecessary. Similarly, in the case where the inventory information of the remote terminal 104 is determined to be more secure than the recommended inventory information, the inventory comparison section 510 is capable of determining that the fraud detection is unnecessary. The inventory comparison section 510 instructs the fraud detection confirmation reply frame producing section 514 to produce the fraud detection confirmation reply frame including the determination result.

(Recommended Inventory Information holding DB)

The recommended inventory information holding DB 512 holds the inventory information of the terminal that is recommended by the enterprise network 114 in advance. The inventory information of the terminal that is recommended by the enterprise network 114 can be updated by an administrator of the enterprise network 114 as needed. The administrator of the enterprise network 114 make a database of pattern file information of virus check software or an OS security hole countermeasure patch information which are recommended at the remote terminal at the time of connecting the enterprise network in advance. Then, the administrator of the enterprise network 114 is capable of holding the database in the recommended inventory information holding DB 512.

(Fraud Detection Confirmation Reply Frame Producing Section)

The fraud detection confirmation reply flame producing section 514 produces the fraud detection confirmation reply frame according to an instruction from the inventory comparison section 510. The frame is transmitted to the VPN-GW 103 through the communication section 501.

<Operational Example>

A description will be given of an operational example in the case where a user of the enterprise network 114 connects to the enterprise network 114 by using the remote terminal 104 on the external network 100.

(Case where fraud detection is not conducted)

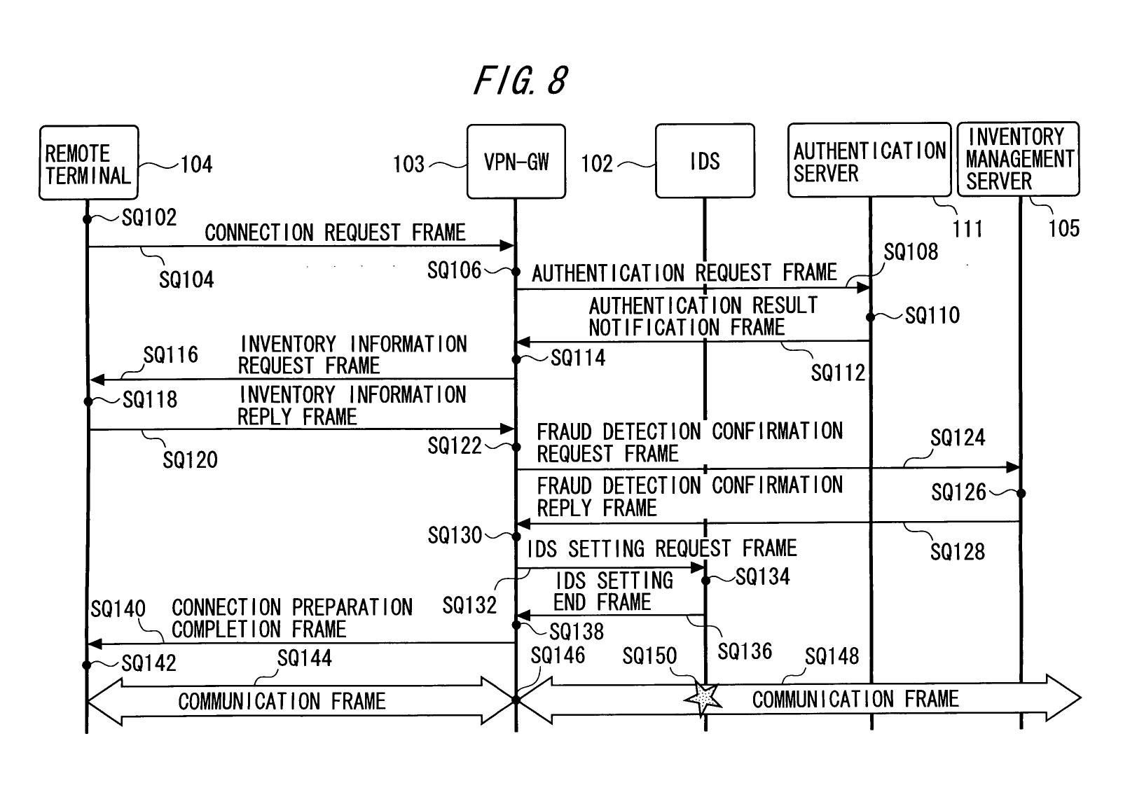

FIG. 8 is a diagram showing a sequence example in the case where fraud detection is not conducted.

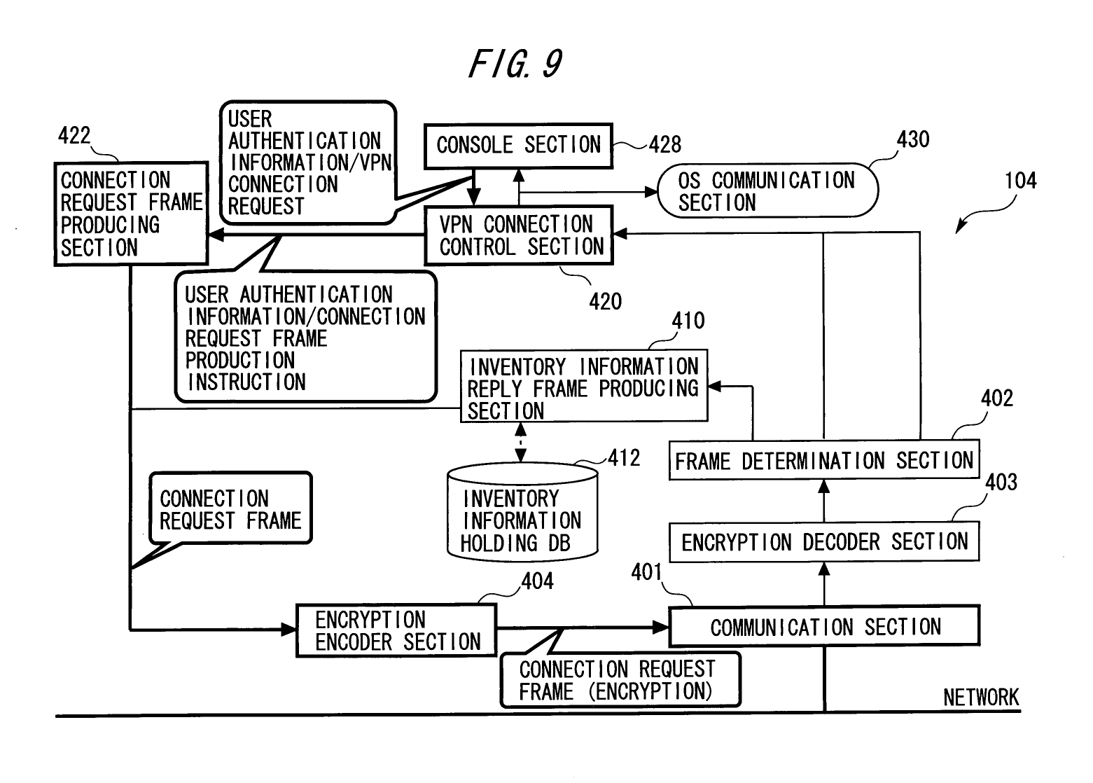

The remote terminal 104 requires a connection to the enterprise network 114 (FIG. 8; SQ 102). FIG. 9 is a diagram showing a flow of processing at the remote terminal at that time. The user who requests the connection to the enterprise network from the external network 100 requests the user authentication information as well as the connection through the console section 228 of the remote terminal 104. The console section 228 transmits the user authentication information to the VPN connection control section 420, and instructs the VPN connection to the VPN connection control section 420. The VPN connection control section 420 transmits the user authentication information to the connection request frame producing section 422, and instructs the connection request frame producing section 422 to produce the connection request frame. The connection request frame producing section 422 produces the connection request frame, and transmits the connection request frame to the communication section 401 through an encrypting process conducted by the encryption encoder section 404.

The communication section 401 of the remote terminal 104 transmits a connection request (connection request frame) to the enterprise network 114 with respect to the VPN-GW 103 (FIG. 8; SQ 104).

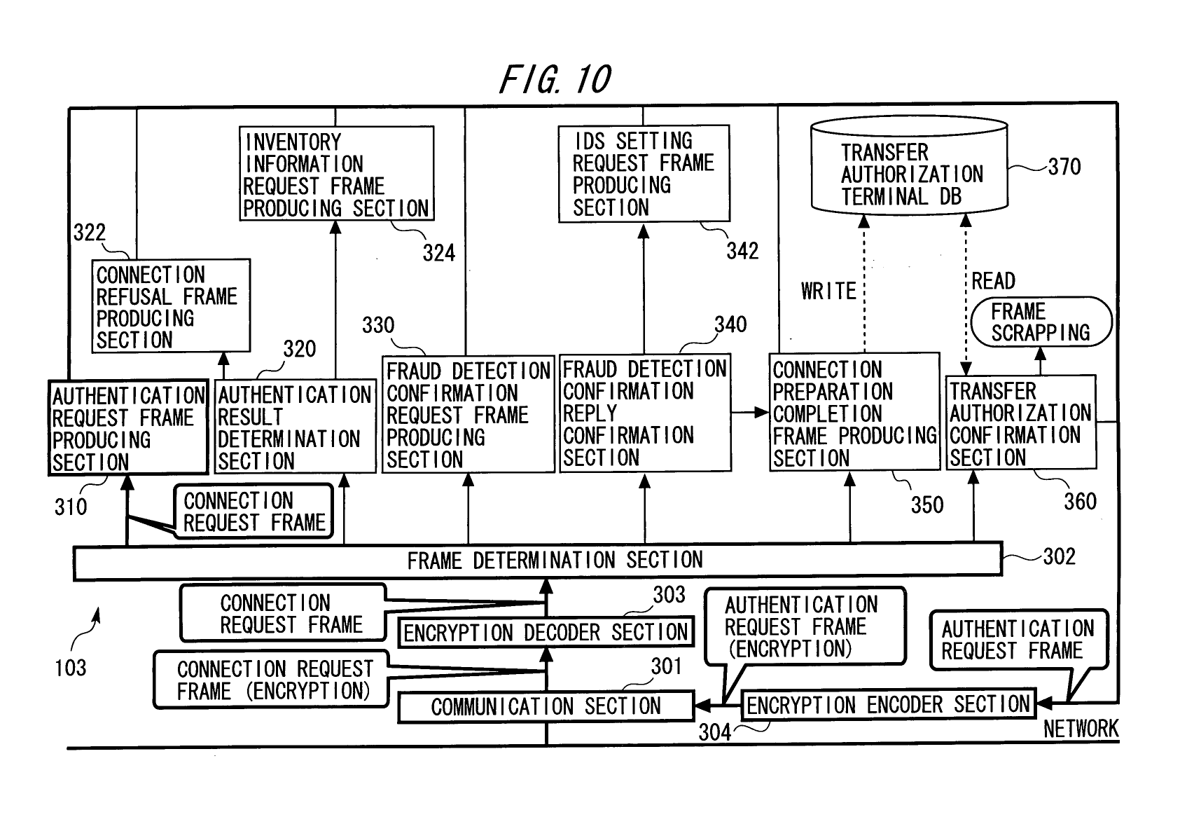

The VPN-GW 103 receives the connection request frame, and produces the authentication request frame (FIG. 8, SQ 106). FIG. 10 is a diagram showing a flow of processing in the VPN-GW 103 at that time. Upon receiving the connection request frame from the remote terminal 104, the communication section 301 transfers the frame to the encryption decoder section 303. The encryption decoder section 303 decodes the connection request frame, and transfers the decoded frame to the frame determination section 302. The frame determination section 302 transfers the connection request frame to the authentication request frame producing section 310. The authentication request frame producing section 310 produces the authentication request frame including the user authentication information that is included in the connection request frame, and transmits the authentication request frame to the communication section 301 through the encryption encoder section 304. The authentication request frame is not encrypted in the encryption encoder section 304. This is because the authentication request frame is a frame that is transmitted to the authentication server 111.

The communication section 301 of the VPN-GW 103 transmits the authentication request frame to the authentication server 111 (FIG. 8; SQ 108).

The authentication server 111 confirms whether the user authentication information that is included in the authentication request frame has been registered or not (FIG. 8; SQ 110). Upon confirming that the user authentication information has been registered, the authentication server 111 produces the authentication result notification frame and transmits the produced authentication result notification frame to the VPN-GW 103 (FIG. 8; SQ 112).

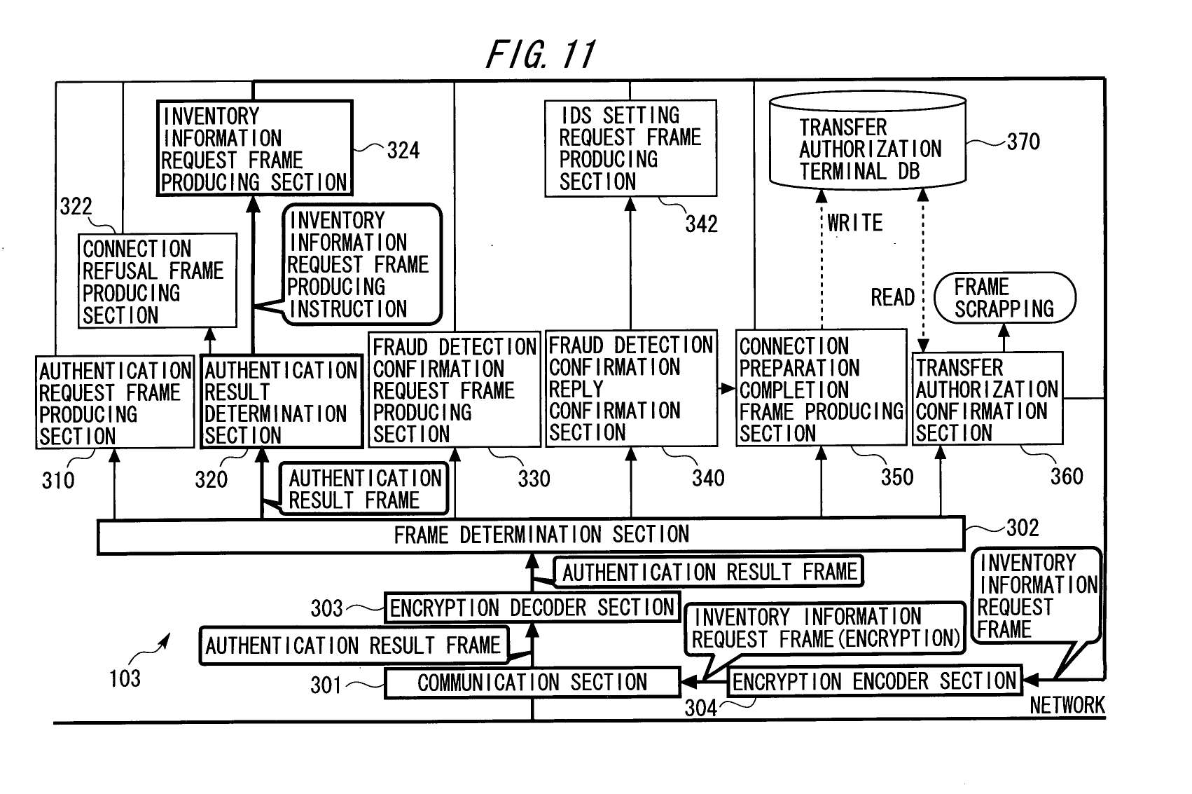

The VPN-GW 103 receives the authentication result notification frame from the authentication server 111, and then transmits the inventory information request frame to the remote terminal 104 when the authentication is acceptable (FIG. 8; SQ 114). FIG. 11 is a diagram showing a flow of processing in the VPN-GW 103 at that time. The communication section 301 transmits the authentication result notification frame to the frame determination section 302 through the encryption decoder section. The frame determination section 302 transmits authentication result notification frame to the authentication result determination section 320. In the case where the authentication is acceptable, the authentication result determination section 320 instructs the inventory information request frame producing section 324 to produce the inventory information request frame. The inventory information request frame producing section 324 produces the inventory information request frame with respect to the remote terminal 104, and encrypts the produced inventory information request frame by the encryption encoder section 304. The encrypted inventory information request frame is transmitted to the communication section 301.

The communication section 304 of the VPN-GW 103 transmits the inventory information request frame to the remote terminal 104 (FIG. 8; SQ 116).

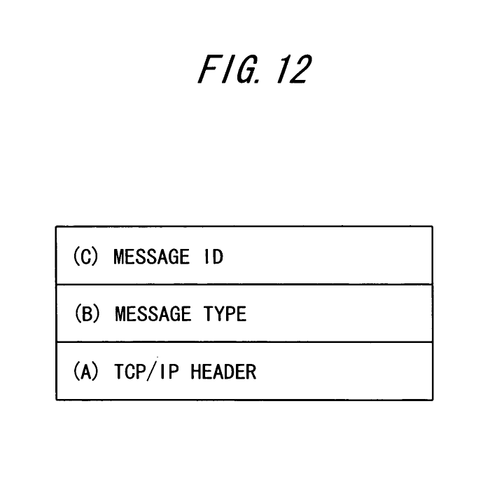

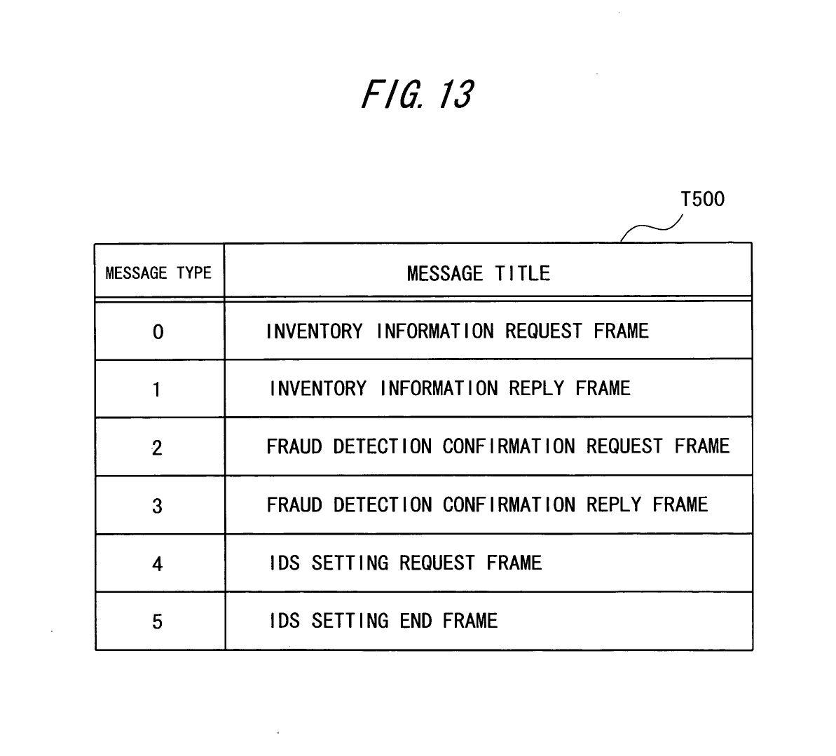

FIG. 12 is a diagram showing a format example of an inventory information request frame. Referring to FIG. 12, the inventory information request frame includes, for example, a TCP/IP header, a message type, and a message ID. The field of the TCP/IP header is a field for storing the existing TCP/IP header. The field of the message type is a field indicative of the message type. The field of the message ID is a field for storing ID for uniquely identifying the message by a device that transmits and receives the inventory information request frame. FIG. 13 shows a table T500 indicative of a correspondence between message types, which are stored in the field of the message type, and message titles. For example, when the message type is “0”, the table indicates that the frame is “inventory information request frame”. The inventory information request frame producing section 324 sets “0” in the message type field according to the table T500.

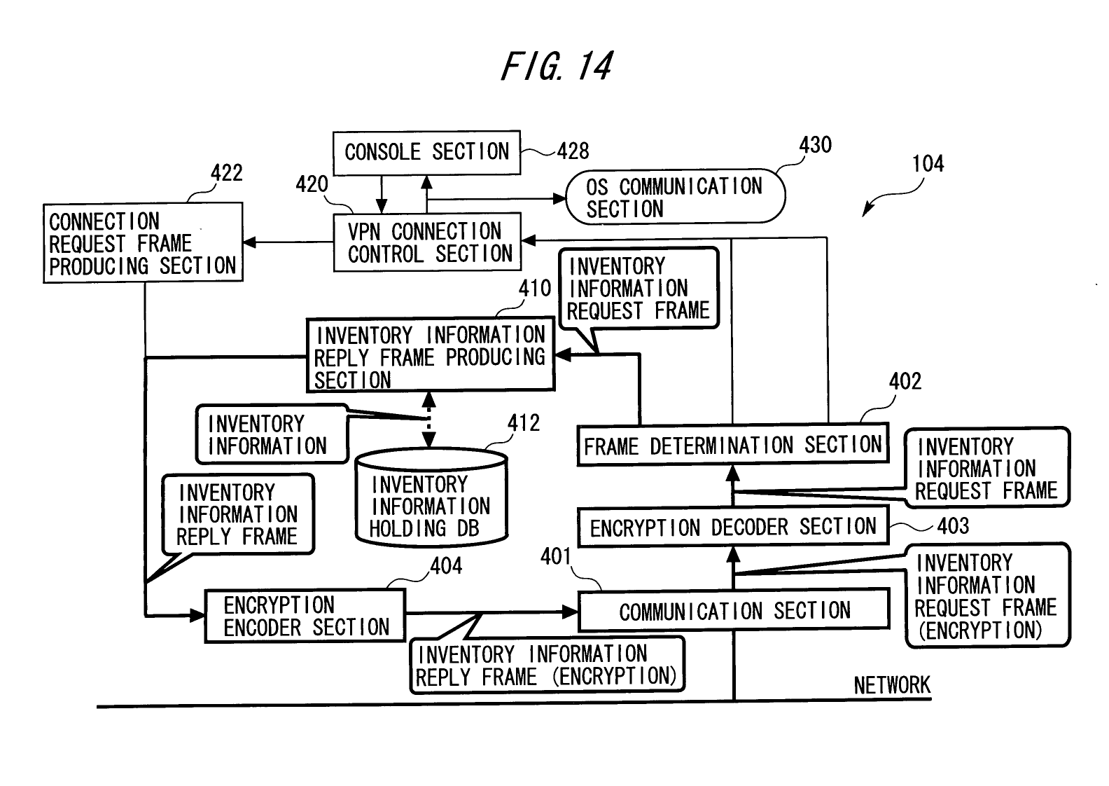

Upon receiving the inventory information request frame, the remote terminal 104 produces the inventory information reply frame (FIG. 8; SQ 118). FIG. 14 is a diagram showing a flow of processing at the remote terminal 104 at that time. Upon receiving the inventory information request frame, the communication section 401 decodes the frame by the encryption decoder section 403, and transmits the decoded frame to the frame determination section 402. The frame determination section 402 transmits the inventory information request frame to the inventory information reply frame producing section 410. The inventory information reply frame producing section 410 acquires the inventory information that has been required by the inventory information request frame from the inventory information holding DB 412. The inventory information reply frame producing section 410 produces the inventory information reply frame according to the acquired information, and encrypts the frame by the encryption encoder section 404. The encrypted inventory information reply frame is transmitted to the communication section 401.

The communication section 401 of the remote terminal 104 transmits the inventory information reply frame to the VPN-GW 103 (FIG. 8; SQ 120).

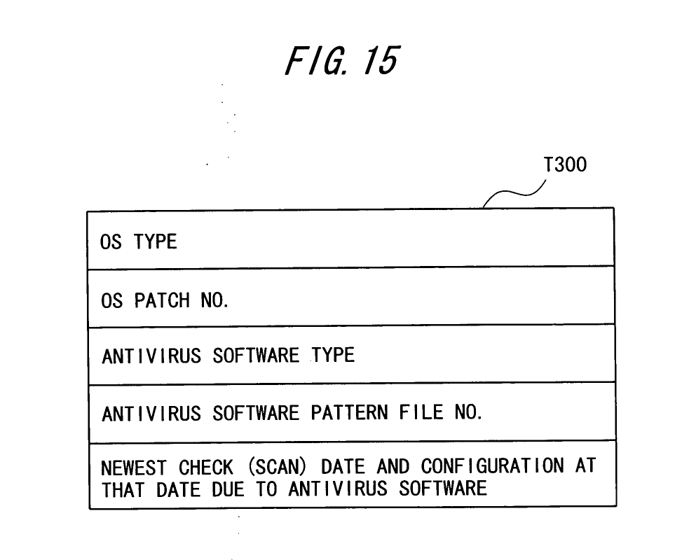

The inventory information reply frame includes, for example, an OS type, an OS patch number, an antivirus software type, a pattern file number of the antivirus software, newest check (scan) date by the antivirus software, and the configuration at the date as the inventory information. FIG. 15 shows a structural example of information that is included in the inventory information.

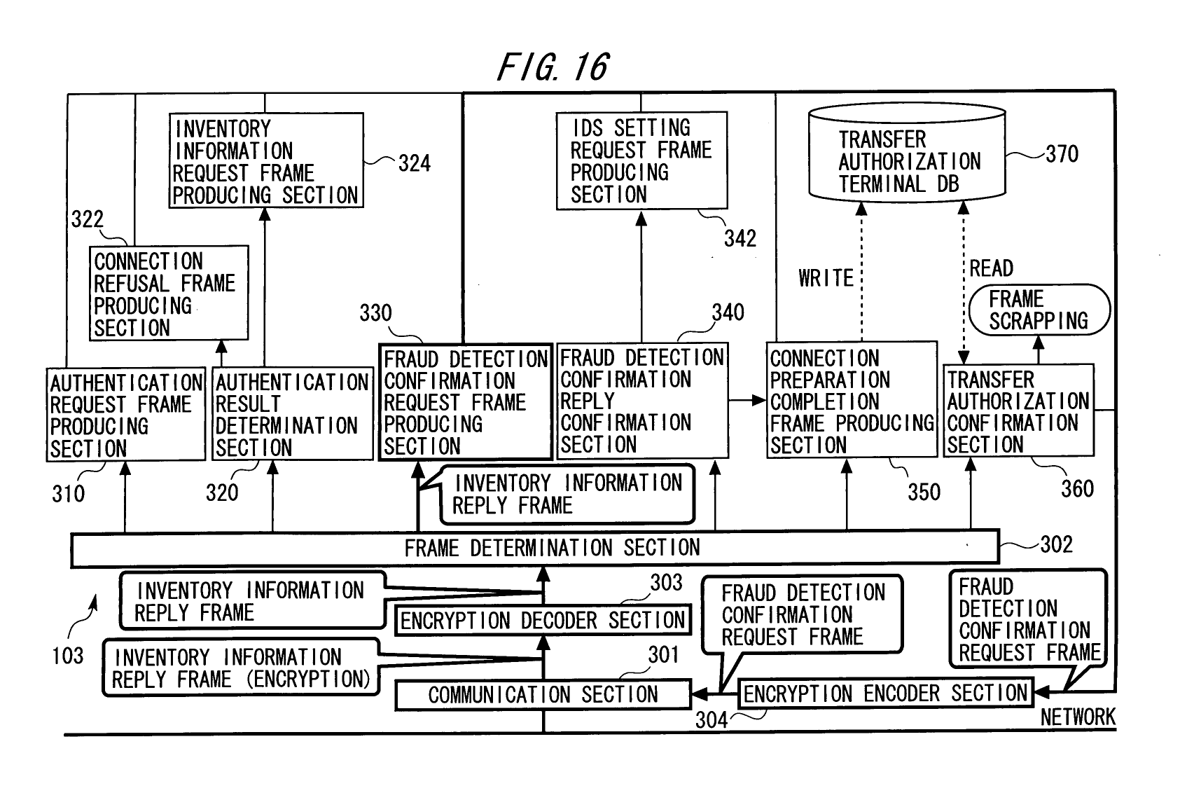

The VPN-GW 103 produces a fraud detection confirmation frame including the inventory information of the remote terminal 104 which has been obtained by the inventory information reply frame (FIG. 8; SQ 122). FIG. 16 is a diagram showing a flow of processing in the VPN-GW 103 at that time. The communication section 301 decodes the inventory information reply frame by the encryption decoder section 303, and transmits the decoded inventory information reply frame to the frame determination section 302. The frame determination section 302 transmits the inventory information reply frame to a fraud detection confirmation request frame producing section 330. The fraud detection confirmation request frame producing section 330 produces the fraud detection confirmation request frame including the inventory information of the remote terminal 104, and transmits the produced fraud detection confirmation request frame to the communication section 301.

The communication section 301 of the VPN-GW 103 transfers the fraud detection confirmation request frame to the inventory management server 105 (FIG. 8; SQ 124).

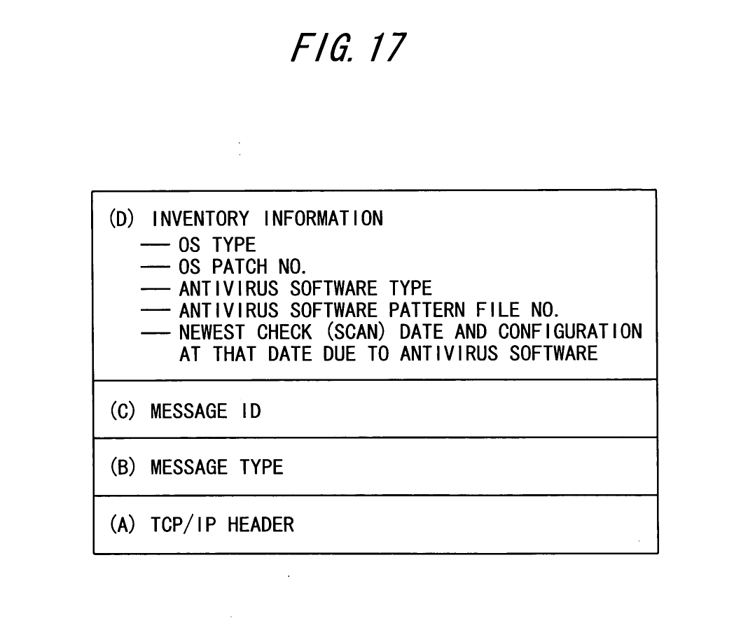

FIG. 17 is a diagram showing a format example of the inventory information request frame. The inventory information reply frame includes, for example, a TCP/IP header, a message type, a message ID, and fields of the inventory information. The field of the TCP/IP header is a field for storing the existing TCP/IP header. The field of the message type is a field indicative of the message type. The field of the message ID is a field for storing the same value as the message ID of the received inventory information request frame. The field of the inventory information is a field for storing inventory information.

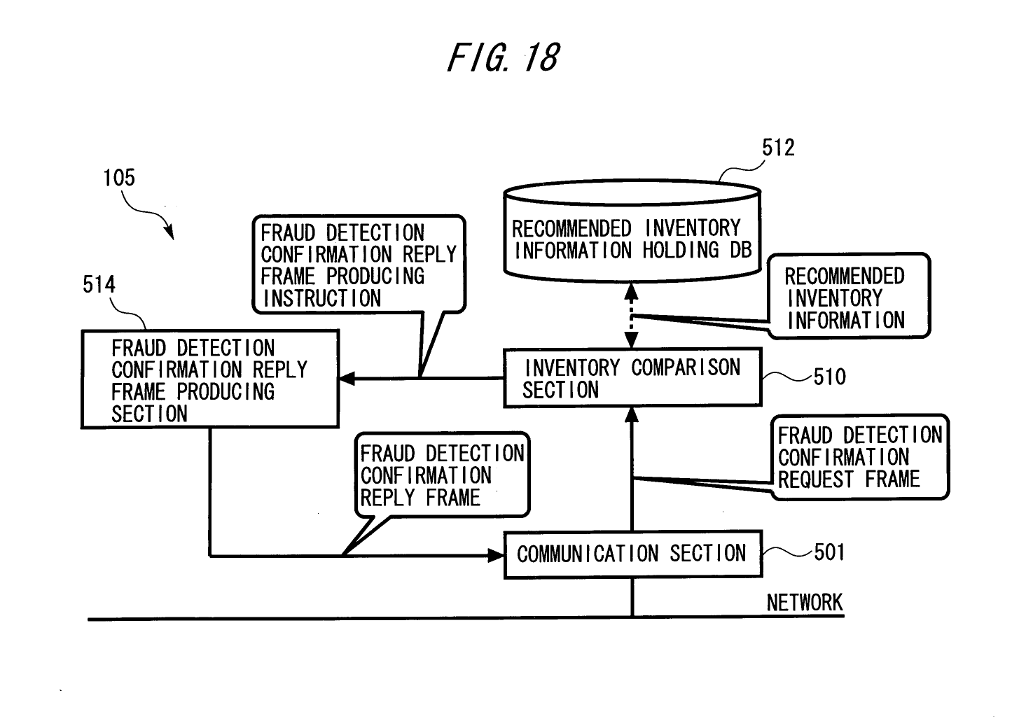

The inventory management server 105 receives the fraud detection confirmation request frame, and produces a fraud detection confirmation reply frame (FIG. 8; SQ 126). FIG. 18 is a diagram showing a flow of processing in the inventory management server 105. The communication section 501 transmits the fraud detection confirmation request frame that has been received from the VPN-GW 103 to an inventory comparison section 510. The inventory comparison section 510 compares the recommended inventory information of the recommended inventory information holding DB 512 with the inventory information of the remote terminal 104. As a result of comparison, when the inventory comparison section 510 determines that the fraud detection is unnecessary in the IDS 102, the inventory comparison section 510 instructs the fraud detection confirmation reply frame producing section 514 to produce fraud detection confirmation reply frame including the determination result. The fraud detection confirmation reply frame producing section 514 produces the fraud detection confirmation reply frame including the fact that the fraud detection is unnecessary, and transmits the produced fraud detection confirmation reply frame to the communication section 501.

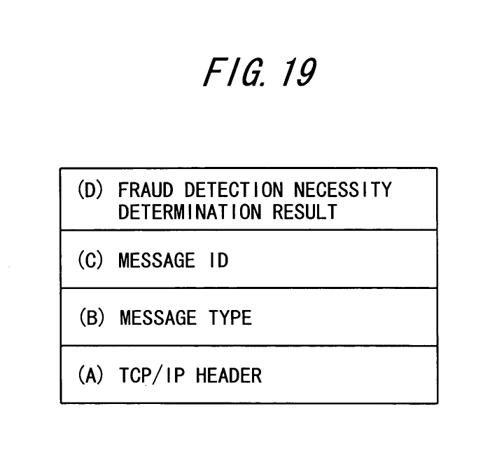

FIG. 19 is a diagram showing a format example of the fraud detection confirmation reply frame. The fraud detection confirmation reply frame includes, for example, respective fields of the TCP/IP header, the message type, the message ID, and the fraud detection necessity determination result. The field of the TCP/IP header is a field that stores the existing TCP/IP header therein. The field of the message type is a field indicative of the message type. The field of the message ID is a field that stores the same value as the message ID of the received fraud detection confirmation request frame therein. The field of the fraud detection necessity determination result is a field that stores therein the result of comparing the inventory information that has been received by the fraud detection confirmation request frame with the recommended inventory information, that is, the result of determining whether or not the fraud detection is necessary in the IDS.

The communication section 501 of the inventory management server 105 transmits the fraud detection confirmation reply frame to the VPN-GW 103 (FIG. 8; SQ 128).

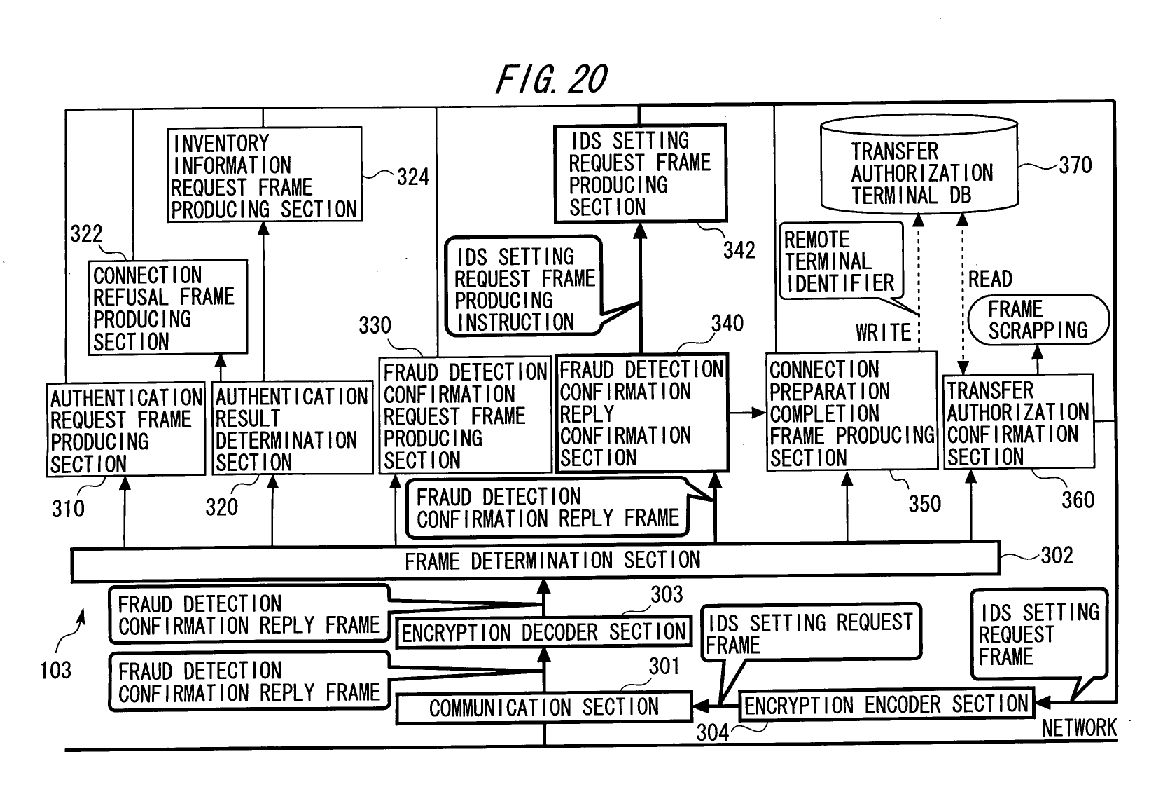

The VPN-GW 103 receives the fraud detection confirmation reply frame and produces an IDS setting request frame (FIG. 8; SQ 130). FIG. 20 is a diagram showing a flow of processing in the VPN-GW 103 at that time. The communication section 301 transmits the fraud detection confirmation reply frame to the frame determination section 302. The frame determination section 302 transmits the fraud detection confirmation reply frame to a fraud detection confirmation reply confirmation section 340. In the case where the fraud detection is unnecessary according to the determination result in the fraud detection confirmation reply frame, the fraud detection confirmation reply confirmation section 340 instructs the IDS setting request frame producing section 342 to produce a frame that notifies the IDS 102 that the frame, which is transmitted by the remote terminal 104 after the VPN connection, is not subjected to the fraud detecting process. The IDS setting request frame producing section 342 produces the IDS setting request frame, and encrypts the produced IDS setting request frame by the encryption encoder section 304. The encrypted IDS setting request frame is transmitted to the communication section 301.

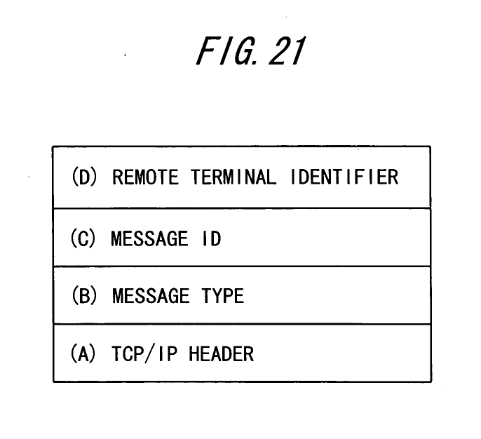

FIG. 21 is a diagram showing a format example of the IDS setting request frame. The IDS setting request frame includes, for example, the respective fields of the TCP/IP header, the message type, the message ID, and the remote terminal identifier. The field of the TCP/IP header is a field for storing the existing TCP/IP header. The field of the message type is a field indicative of the message type. The field of the message ID is a field for storing ID that uniquely identifies the message by a device that transmits and receives the IDs setting request frame therein. A field of the remote terminal identifier is a field for storing the identifier of the remote terminal that does not conduct fraud detection by the IDS therein.

The communication section 304 of the VPN-GW 103 notifies the IDS 102 of the identifier (for example, IP address) of the remote terminal 104 by the IDS setting request frame (FIG. 8; SQ 132).

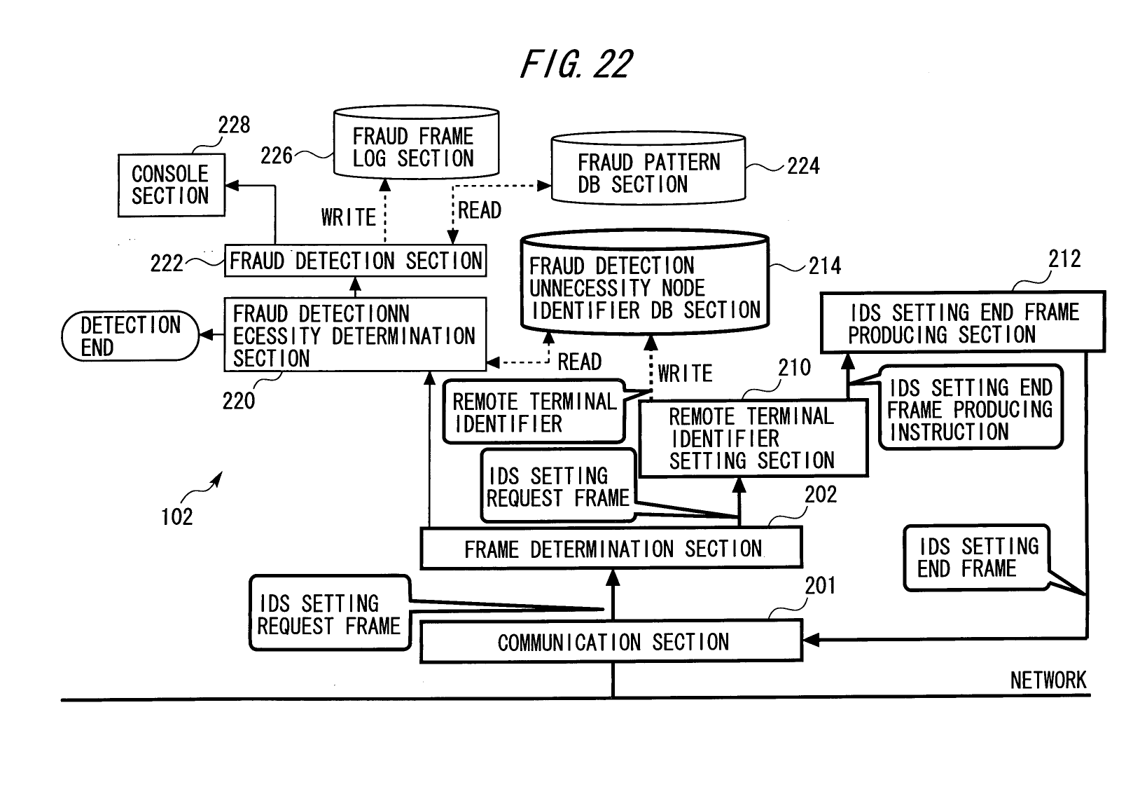

The IDS 102 sets up that the fraud detection is not conducted on a frame having the identifier of the remote terminal 104 as a transmission source within its own device (FIG. 8; SQ 134). FIG. 22 is a diagram showing a flow of processing in the IDS 102 at that time. The communication section 201 transmits the IDS setting request frame to the frame determination section 202. The frame determination section 202 transmits the frame to the remote terminal identifier setting section 210. The remote terminal identifier setting section 210 stores the identifier of the remote terminal 104 that is included in the IDS setting request frame in the fraud detection unnecessity node identifier DB section 214. Also, the remote terminal 210 instructs the IDS setting end frame producing section 212 to produce an IDS setting end frame. The IDS setting end frame producing section produces the IDS setting end frame, and transmits the IDS setting end frame to the communication section 201.

The communication section 201 of the IDS 102 notifies the VPN-GW 103 of the setting completion by the IDS setting end frame (FIG. 8; SQ 136).

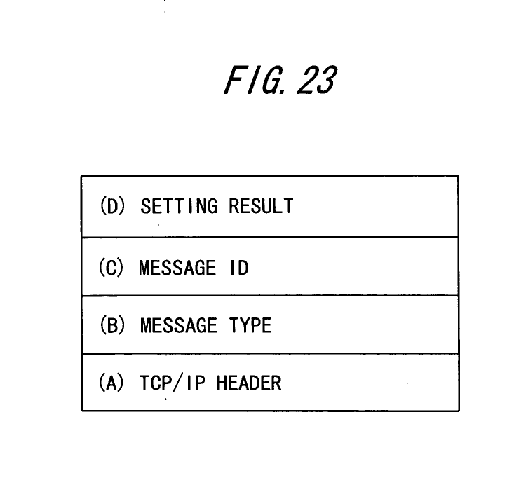

FIG. 23 is a diagram showing a format example of the IDS setting end frame. The IDS setting end frame includes, for example, respective fields of the TCP/IP header, the message type, the message ID, and the setting results. The field of the message ID is a field having the same value as that of the message ID of the received IDS setting request frame. The field of the setting result is a field that notifies the VPN-GW 103 of the result of conducting a setup that the IDS 102 which has received the IDS setting request frame does not conduct fraud detection.

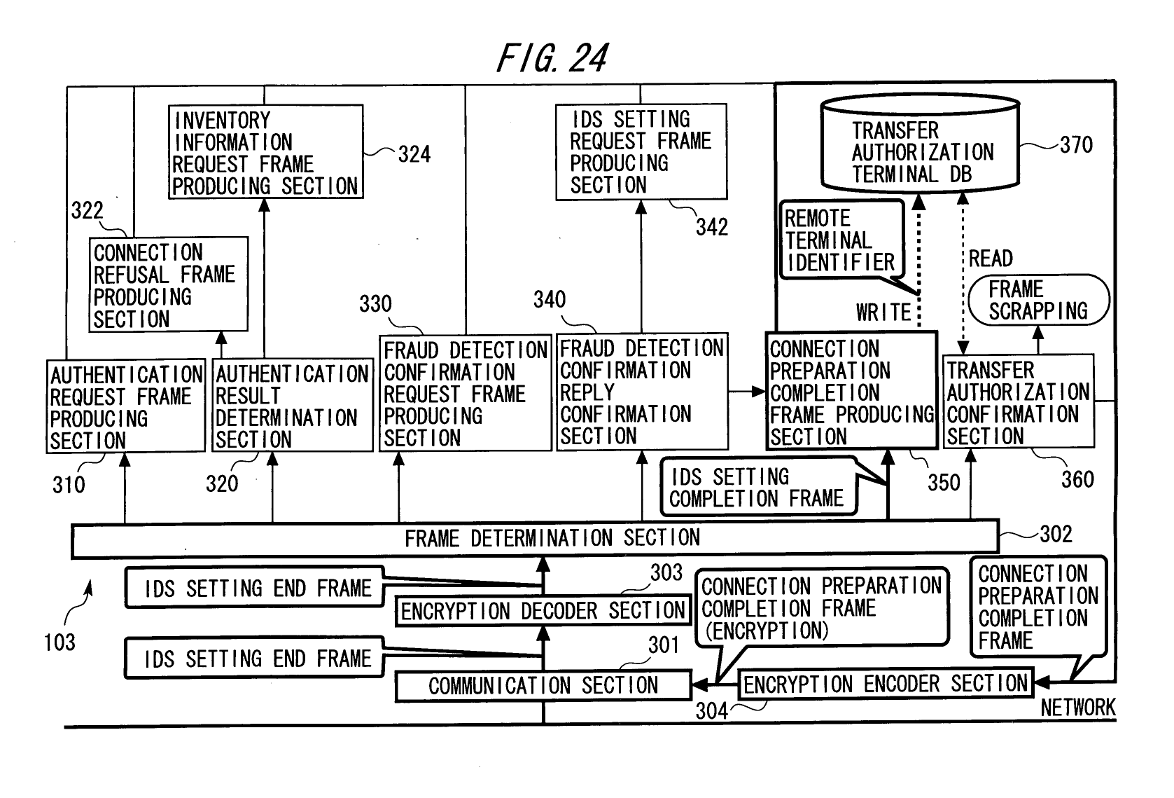

The VPN-GW 103 receives the IDS setting end frame and produces a connection preparation end frame (FIG. 8; SQ 138). FIG. 24 is a diagram showing a flow of processing in the VPN-GW 103 at that time. The communication section 301 transmits the received IDS setting end frame to the frame determination section 302. The frame determination section 302 transmits the frame to the connection preparation completion frame producing section 350. The connection preparation completion frame producing section 350 stores the identifier of the remote terminal 104, which is included in the connection preparation completion frame, in the transfer authorization terminal DB 370. The connection preparation completion frame producing section 350 produces the connection preparation completion frame that notifies that the connection preparation with respect to the remote terminal 104 is completed, and encrypts the frame by the encryption encoder section 304. The encrypted connection preparation completion frame is transmitted to the communication section 301.

The communication section 301 of the VPN-GW 103 transmits the connection preparation completion frame to the remote terminal 104 (FIG. 8; SQ 140).

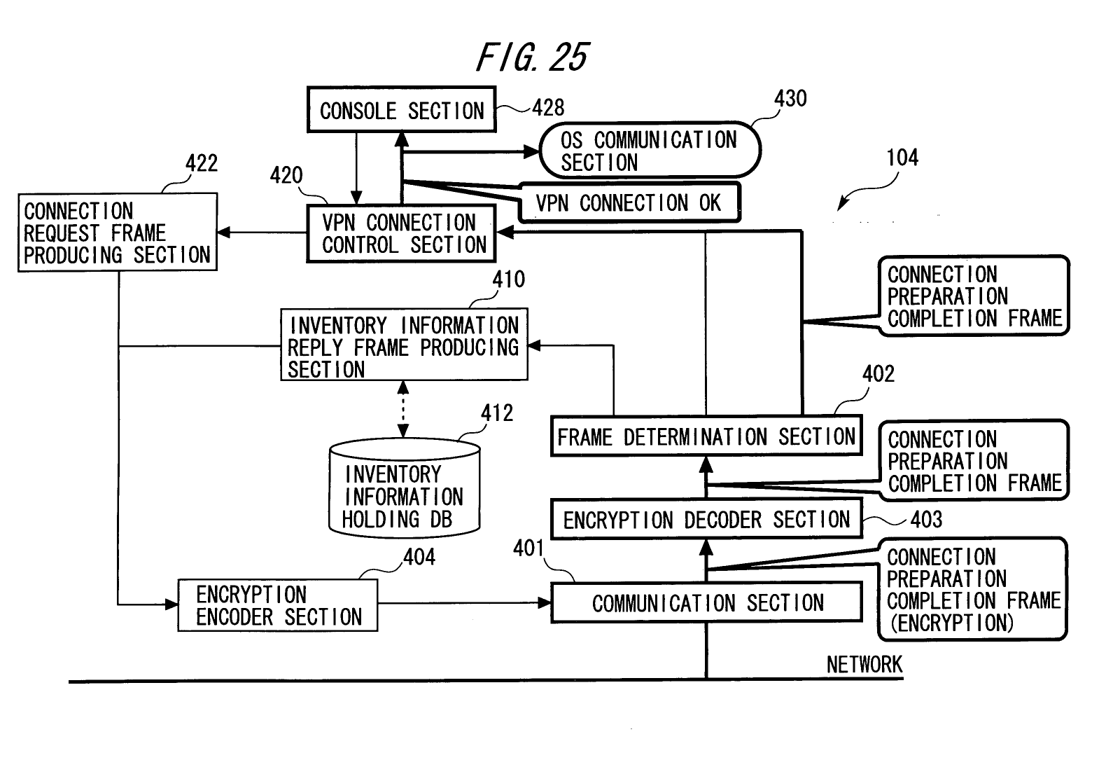

Upon receiving the connection preparation completion frame, the remote terminal 104 prepares connection to the enterprise network 114 (FIG. 8; SQ 142). FIG. 25 is a diagram showing a flow of processing in the remote terminal 104 at that time. The communication section 401 decodes the received connection completion frame by the encryption decoder section, and transmits the decoded connection completion frame to the frame determination section 402. The frame determination section transmits the connection preparation completion frame to the VPN connection control section 420. The VPN connection control section 420 notifies the OS communication section 430 of its own terminal that the VPN connection has been performed. Also, the VPN connection control section 420 notifies the user that the VPN connection could be performed through a console section 428. As a result, it is possible to conduct a communication from the remote terminal 104 to the enterprise network.

The remote terminal 104 starts the communication with the enterprise network 114 (FIG. 8; SQ 144).

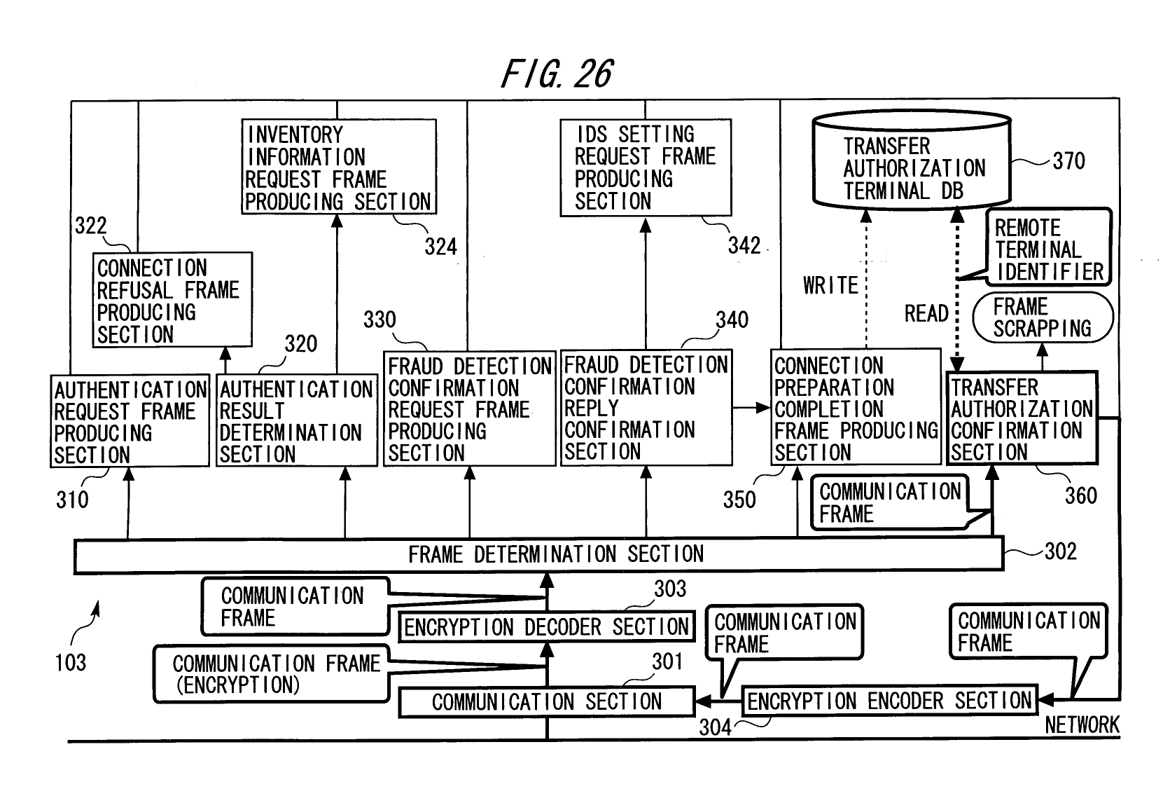

Upon receiving the frame of the communication from the remote terminal 104, the VPN-GW 103 determines whether the transfer can be conducted or not, and when transfer can be conducted, the VPN-GW 103 transfers the frame to the enterprise network 114 (FIG. 8; SQ 146). FIG. 26 is a diagram showing a flow of processing in the VPN-GW 103 at that time. Upon receiving the frame of the communication from the remote terminal 104, the communication section 301 transmits the frame to the encryption decoder section 303. The encryption decoder section decodes the frame and transmits the decoded frame to the frame determination section 302. The frame determination section 302 transmits the decoded frame to the transfer authorization confirmation section 360. The transfer authorization confirmation section 360 confirms whether or not an identifier of a transmission source of the received frame (that is, an identifier of the remote terminal 104) exists in the transfer authorization terminal DB 370. In the case where the identifier exists in the transfer authorization terminal DB 370, the transfer authorization confirmation section 360 transmits the frame to the communication section 301 through the encryption encoder section.

The communication section 301 of the VPN-GW 103 transfers the frame received from the transfer authorization confirmation section 360 to a destination node within the enterprise network 114 (FIG. 8; SQ 148).

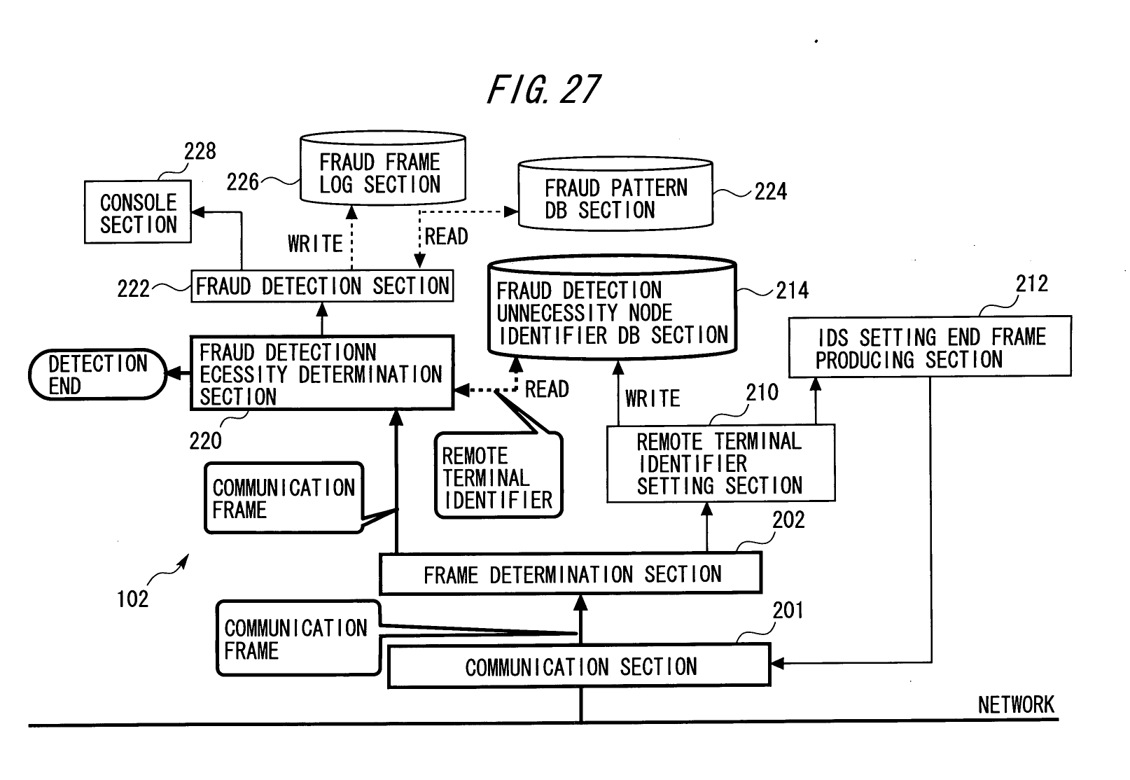

The IDS 102 does not conduct the fraud detection on the communication from the remote terminal 104 (FIG. 8; SQ 150). FIG. 27 is a diagram showing a flow of processing in the IDS 102 at that time. The communication section 201 transmits the received communication frame from the remote terminal 104 to the frame determination section 202. The frame determination section 202 transmits the frame to the fraud detection necessity determination section 220. The fraud detection necessity determination section 220 confirms whether or not the identifier of the transmission source of the received frame exists in the fraud detection unnecessity node identifier DB section 214. In the case where the identifier exists in the fraud detection necessity determination section 220, the fraud detection necessity determination section 220 determines that the fraud detection is unnecessary, and terminates the fraud detection process. In this example, since the identifier of the remote terminal 104 is stored in the fraud detection unnecessity node identifier DB section 214, processing by the fraud detection section 222 is not conducted.

(Case Where Fraud Detection is Conducted)

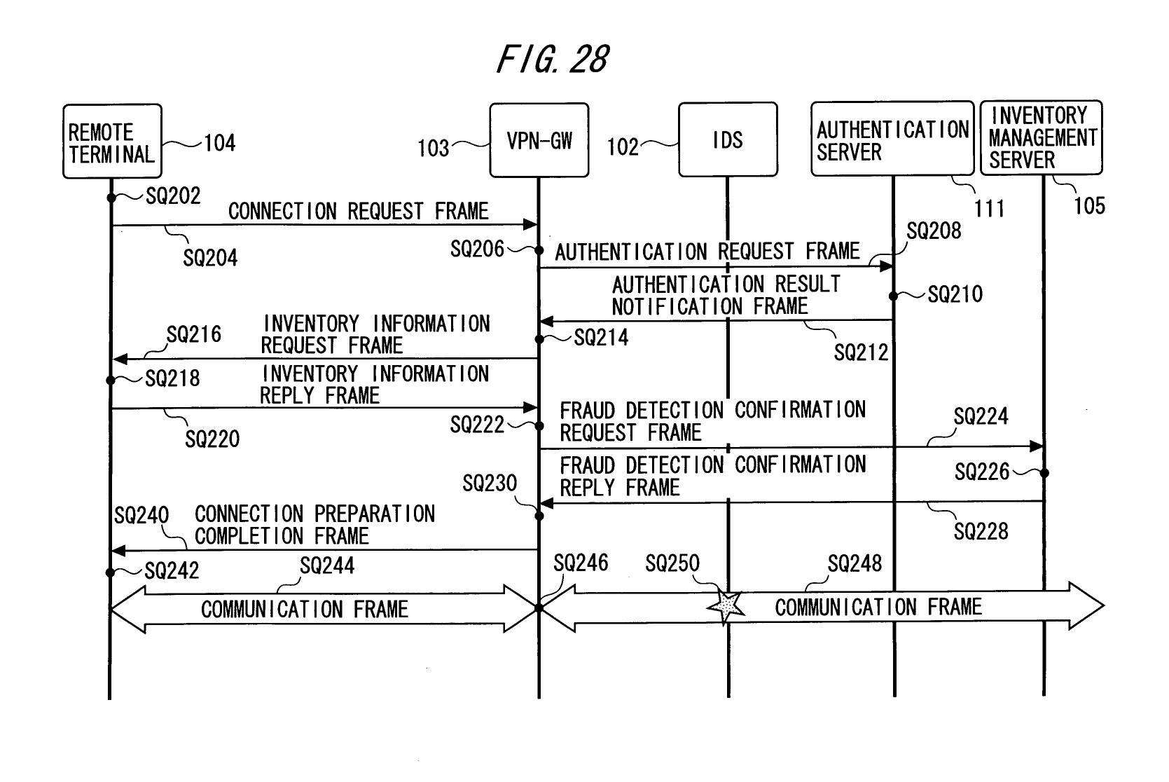

FIG. 28 is a diagram showing a sequential example in a case where the fraud detection is conducted.

The same process as in the case where the fraud detection is not conducted (FIG. 8; SQ 102 to SQ 128) is performed until the VPN-GW 103 receives the fraud detection confirmation reply frame from the inventory management server 105 (FIG. 28; SQ 228) after the remote terminal 104 requests the connection to the enterprise network 114 (FIG. 28; SQ 202). Therefore, description thereof will be omitted.

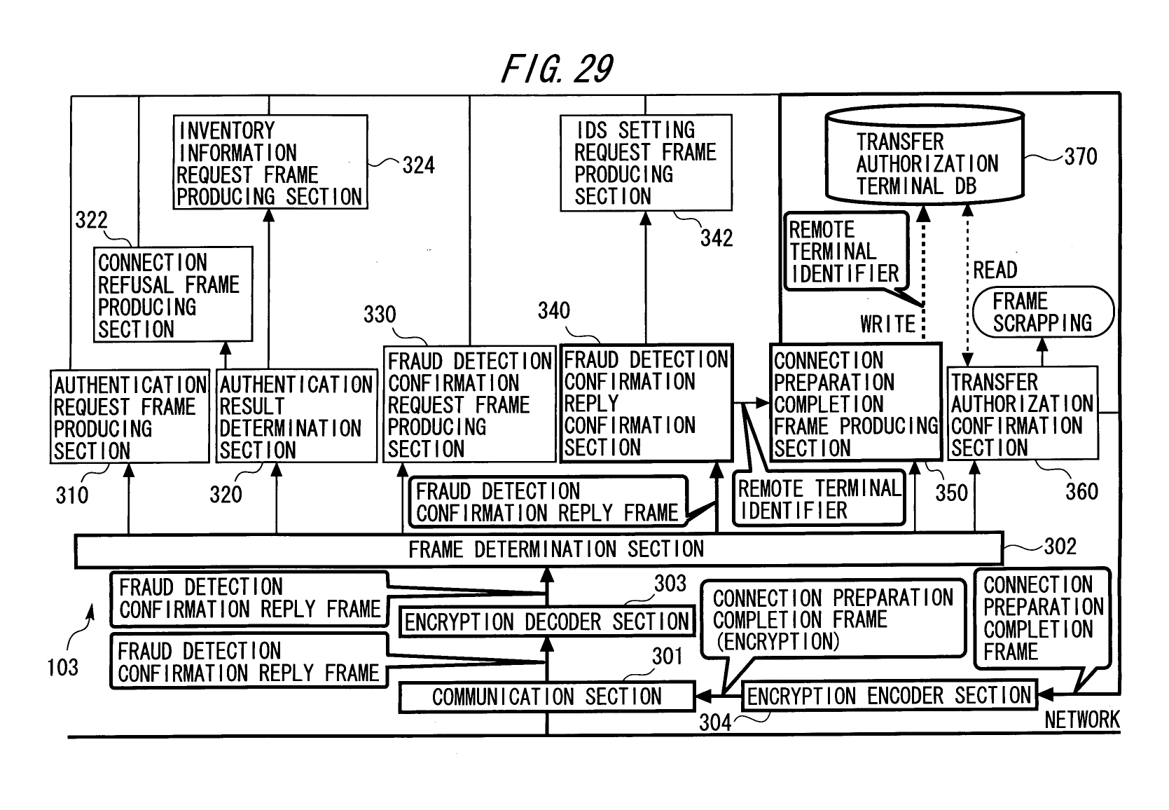

The VPN-GW 103 receives the fraud detection confirmation reply frame including the fraud detection necessity determination result (FIG. 19) that indicates that the fraud detection is necessary, from the inventory management server 105, and transmits the connection preparation completion frame to the remote terminal (FIG. 28; SQ 230). FIG. 29 is a diagram showing a flow of processing in the VPN-GW 103 at that time. Upon receiving the fraud detection confirmation reply frame, the communication section 301 transmits the fraud detection confirmation reply frame to the frame determination section 302 through the encryption decoder section. The frame determination section transmits the frame to the fraud detection confirmation reply confirmation section 340. The fraud detection confirmation reply confirmation section 340 confirms that the received fraud detection confirmation reply frame includes the fact that the fraud detection is necessary. The fraud detection reply confirmation section 340 instructs the connection preparation completion frame producing section 350 to produce the connection preparation completion frame together with the transmission source identifier (identifier of the authenticated remote terminal 104) of the received frame. The connection preparation completion frame producing section 350 stores the identifier of the authenticated remote terminal in the transfer authorization terminal DB. The connection preparation frame producing section 360 produces the connection preparation completion frame and encrypts the connection preparation completion frame by the encryption encoder section. The encrypted connection preparation completion frame is transmitted to the communication section 301. In this example, no instruction is given to the IDS 102, which is different from the case where the fraud detection is not conducted.

The communication section 301 of the VPN-GW 103 transmits the connection preparation completion frame to the remote terminal 104 (FIG. 28; SQ 240).

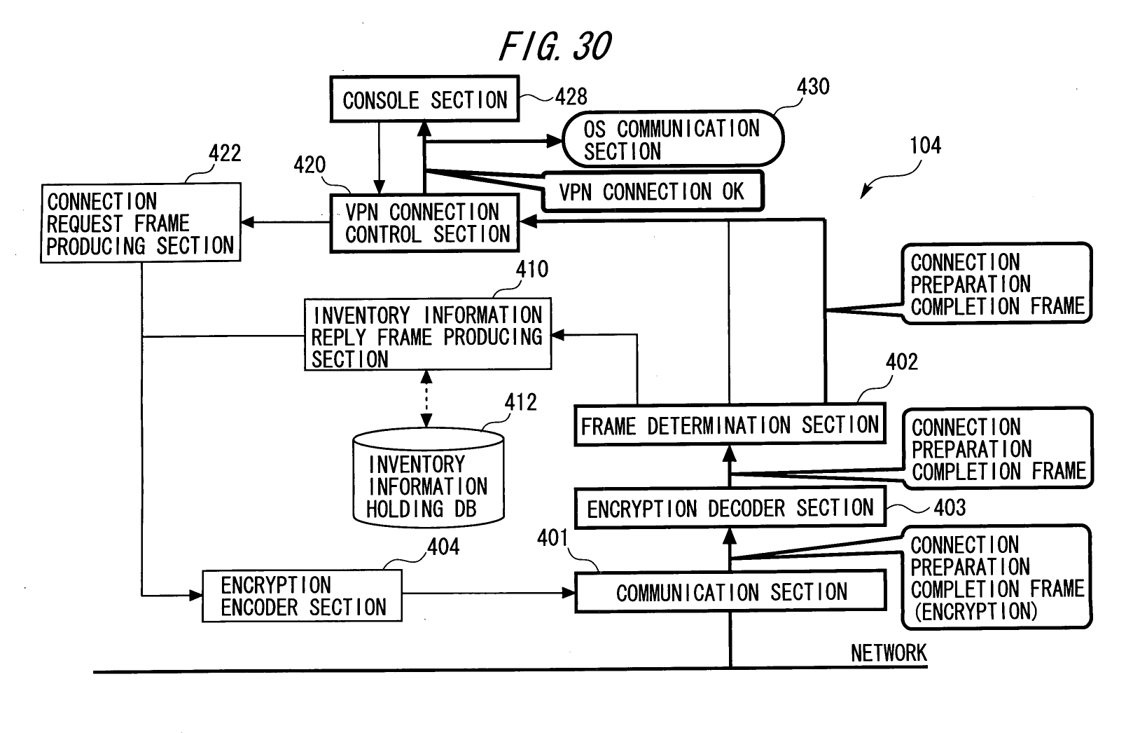

Upon receiving the connection preparation completion frame, the remote terminal 104 prepares the connection to the enterprise network 114 (FIG. 28; SQ 242). FIG. 30 is a diagram showing a flow of processing in the remote terminal 104 at that time. The communication section 401 decodes the received connection completion frame by the encryption decoder section, and transmits the decoded connection completion frame to the frame determination section 402. The frame determination section 402 transmits the connection preparation completion frame to a VPN connection control section 420. The VPN connection control section 420 notifies an OS communication section 430 of its own terminal that the VPN connection is made. Also, the VPN connection control section 420 notifies the user that the VPN connection is made through a console section 428. As a result, it is possible to conduct a communication from the remote terminal 104 to the enterprise network.

The remote terminal 104 starts a communication with the enterprise network 114 (FIG. 28; SQ 244).

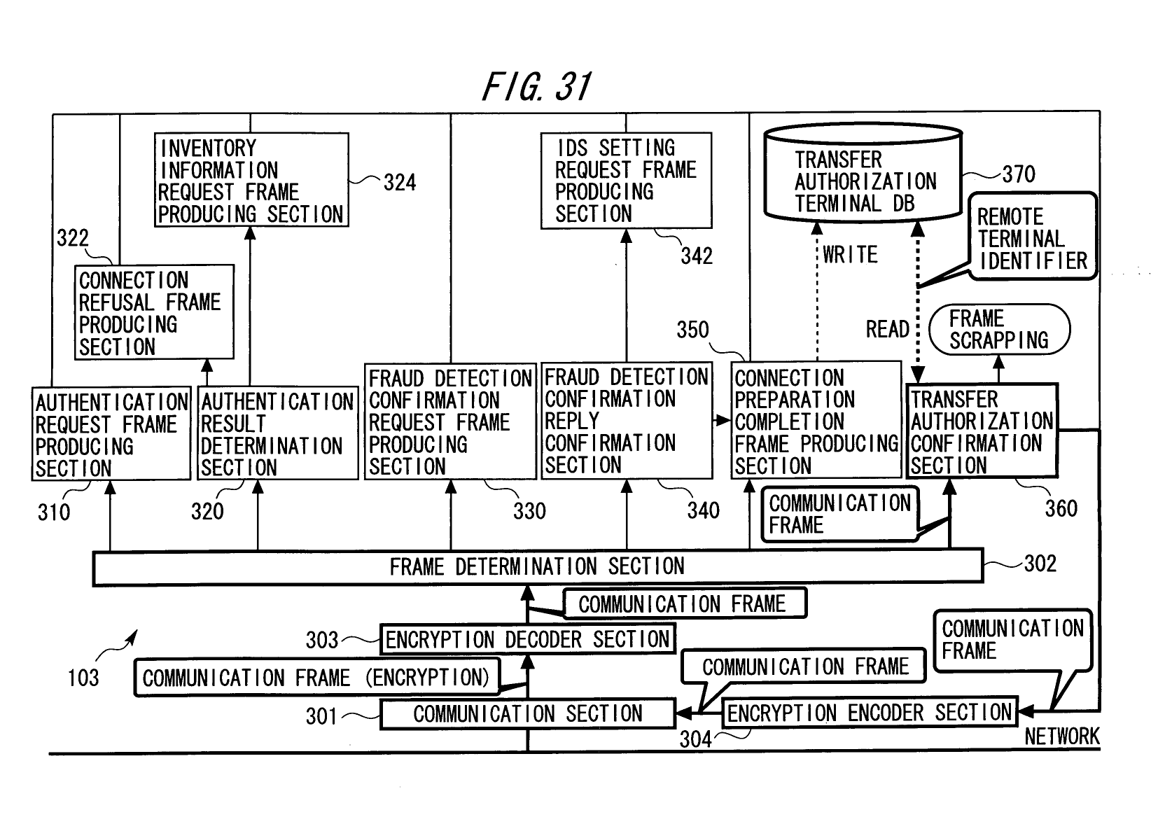

Upon receiving the frame of the communication from the remote terminal 104, the VPN-GW 103 determines whether the transfer can be conducted or not, and transfers the frame to the enterprise network 114 when the transfer can be conducted (FIG. 28; SQ 246). FIG. 31 is a diagram showing a flow of processing in the VPN-GW 103 at that time. Upon receiving the frame of the communication from the remote terminal, the communication section 301 transmits the frame to the encryption decoder section 303. The encryption decoder section decodes the frame and transmits the decoded frame to the frame determination section 302. The frame determination section 302 transmits the decoded frame to the transfer authorization confirmation section 360. The transfer authorization confirmation section 360 confirms whether or not the identifier of the transmission source of the received frame exists in the transfer authorization terminal DB 370. In the case where the identifier exists in the transfer authorization terminal DB 370, the transfer authorization confirmation section 360 transmits the frame to the communication section 301 through the encryption encoder section 304.

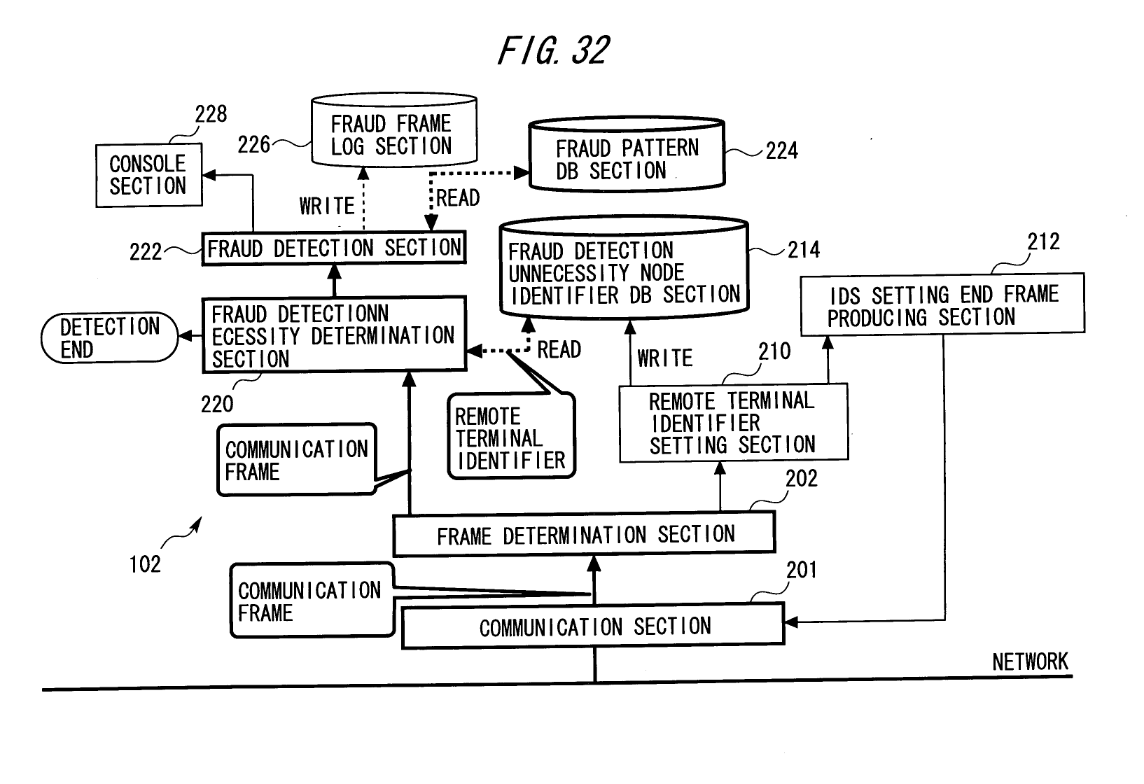

The IDS 102 conducts the fraud detection on the communication from the remote terminal 104 (FIG. 28; SQ 250). FIG. 32 is a diagram showing a flow of processing in the IDS 102 at that time. The communication section 201 transmits the received frame to the frame determination section 202. The frame determination section 202 transmits the frame to the fraud detection necessity determination section 220. The fraud detection necessity determination section 220 confirms whether or not the identifier of the transmission source of the received frame exists in the fraud detection unnecessity node identifier DB section 214. In the case where the identifier does not exist in the fraud detection necessity determination section 220, the fraud detection necessity determination section 220 determines that the fraud detection is necessary, and transmits the frame to the fraud detection section 222. The fraud detection section 222 conducts the fraud detection according to whether or not the pattern that is held in the fraud pattern DB 224 coincides with the received pattern. In the case of coincidence, because the frame is fraud, the fraud detection section 222 discards the frame, records the information on the fraud frame in the fraud frame-log section 226, and notifies the console section 228. In the case of inconsistency, the fraud detection section 222 determines that the frame has no problem and terminates the processing of the frame.

<Effects of the Embodiments>

According to this embodiment, when a connection request is given to the enterprise network 114 from the remote terminal 104 by an operation of a user or the like, the user authentication by the authentication server 111 is conducted through the VPN-GW 103 of the enterprise network 114. When the user authentication is successful, the VPN-GW 103 requests the inventory information with respect to the remote terminal 104. The inventory management server 105 compares the inventory information of the remote terminal 104 with the recommended inventory information that is registered by an administrator of the enterprise network 114 to determine whether or not the fraud detection is necessary. When the inventory management server 105 determines that the fraud detection is unnecessary, the identifier information of the remote terminal 104 is registered in the IDS 102. Upon completion of the registration in the IDS 102, the remote terminal 104 is notified of the connection preparation completion. The remote terminal 104 starts the communication with respect to the enterprise network 114. In this situation, the IDS 102 does not conduct the fraud detection with respect to the communication frame from the remote terminal 104.

In the case where the remote terminal 104 that is used by the user of the enterprise network 114 outside of the company is secure, that is, in the case where the remote terminal 104 is not infected by a virus or the like, and there is no attack risk against the enterprise network, when the remote terminal 104 is connected to the enterprise network 114, the IDS 102 does not conduct the fraud detection on the network.

The remote terminal 104 ensures security due to the virus check software or the OS security hole countermeasure patch. Therefore, the check of the fraud detection in the IDS on the network is not conducted with respect to the remote terminal 104. In other words, the IDS 102 does not conduct the fraud detection of the frame having no attack risk, and is capable of selectively conducting the fraud detection of other frames (traffic). Therefore, it is possible to conduct efficient fraud detection by the IDS 102.

<Incorporation by reference>

The disclosures of Japanese patent application, No.JP2006-076466 filed on Mar. 20, 2006 including the specification, drawings and abstract are incorporated by reference.

What is claimed is:

1. A frame relay device for relaying a frame that is transferred from a terminal to a network, the frame relay device comprising:
a determination section that determines whether or not an inspection of security of the frame from the terminal is necessary before frame transmission from the terminal to the network starts;
a decision section that decides that the inspection of the security is not conducted on the frame from the terminal in an inspection device that is positioned on a frame transmission path between the frame relay device and the network, receives the frame that is transferred to the network, and conducts the inspection of the security of the frame in a case where the inspection of the security is unnecessary, and decides that the inspection of the security is conducted on the frame from the terminal in the inspection device in a case where the inspection of the security is necessary; and
an output section that outputs an instruction based on the decision result to the inspection device.

2. The frame relay device according to claim 1, wherein the determination section determines whether or not the security of the frame that is transmitted from the terminal satisfies a condition that is required by the network to determine whether or not the inspection is necessary. (2)

3. The frame relay device according to claim 1, wherein the determination section determines whether or not a state for ensuring the security of the transmission frame in the terminal satisfies the condition that is required by the network.

4. The frame relay device according to claim 1, further comprising:
unit for acquiring information related to the security of the terminal from the terminal in a case of receiving a request for connection to the network from the terminal; and
unit for inquiring of the determination device whether or not the inspection is necessary based on the information related to the security of the terminal,
wherein the determination section determines whether or not the inspection is necessary based on a determination result of the determination device.

5. The frame relay device according to claim 1, wherein the determination section determines that the inspection of the security is necessary in a case where a type of operating system that is installed in the terminal is not a type authorized on the network.

6. The frame relay device according to claim 1, wherein the determination section determines that the inspection of the security is necessary in a case where a type of antivirus software that is installed in the terminal is not a type authorized on the network.

7. The frame relay device according to claim 1, wherein the determination section determines that the inspection of the security is necessary in a case where a patch number of the operating system that is installed in the terminal does not satisfy a regulation of the network.

8. The frame relay device according to claim 1, wherein the determination section determines that the inspection of the security is necessary in a case where a pattern file of the antivirus software that is installed in the terminal does not satisfy a regulation of the network.

9. A frame inspection device, comprising:
a frame reception section;
an inspection section that inspects security of a frame;
a storage section that registers identification information of a terminal that does not require inspection of the security by the inspection section therein; and
a determination section that determines not to inspect the frame by the inspection section in a case where the identification information of a transmission source terminal of the frame is not registered in the storage section when the frame is received by the frame reception section.

10. The frame inspection device according to claim 9, further comprising a registration section that receives the identification information of the terminal that does not require the inspection from a frame relay device that relays a frame which is transferred from the terminal to the network, and registers the identification information in the storage section,
wherein the reception section receives the frame from the terminal which is transferred from the frame relay device to the network.
